(19) United States
(12) Patent Application Publication
(10) Pub. No.: US 2019/0392858 A1
(43) Pub. Date: Dec. 26, 2019

(54) INTELLIGENT VOICE OUTPUTTING METHOD, APPARATUS, AND INTELLIGENT COMPUTING DEVICE

(71) Applicant: LG ELECTRONICS INC., Seoul (KR)

(72) Inventor: Bongki LEE, Seoul (KR)

(73) Assignee: LG ELECTRONICS INC., Seoul (KR)

(21) Appl. No.: 16/558,997

(22) Filed: Sep. 3, 2019

(30) Foreign Application Priority Data
Aug. 12, 2019 (KR) 10-2019-0098376

(51) Int. Cl. G10L 25/78; G10L 17/26; G06K 9/00; G06F 3/16; G10L 13/08; G06N 3/08

(52) U.S. Cl. CPC G10L 25/78; G10L 17/26; G06K 9/00624; G06N 3/08; G06F 3/165; G10L 13/08; G06F 3/167

(57) ABSTRACT

Provided are an intelligent voice outputting method and apparatus and an intelligent computing device. The intelligent voice outputting method includes obtaining a voice from a microphone detection signal, capturing an image in a direction in which the microphone detection signal is received, obtaining a distance to a speaker of the voice on the basis of the microphone detection signal and the image, and outputting a response regarding the voice on the basis of the distance to the speaker, whereby effectively transferring a response regarding the voice of the speaker only by the voice outputting apparatus without the help of an external device. At least one of the voice outputting apparatus, the intelligent computing device, and a server may be associated with an artificial intelligence (AI) module, an unmanned aerial vehicle (UAV) (or drone), a robot, an augmented reality (AR) device, a virtual reality (VR) device, and a device related to a 5G service.

### CROSS REFERENCE

This application is based on and claims priority under 35 U.S.C. 119 to Korean Patent Application No. 10-2019-0098376, filed on Aug. 12, 2019, in the Korean Intellectual Property Office, the disclosure of which is herein incorporated by reference in its entirety.

### BACKGROUND OF THE INVENTION

### Field of the invention

The present invention relates to an intelligent voice outputting method and apparatus and an intelligent computing device, and more particularly, to an intelligent voice outputting method and apparatus and an intelligent computing device for intelligently outputting a text-to-speech (TTS).

### Related Art

The voice outputting apparatus is an apparatus which converts a user's voice into text, analyzes a meaning of a message included in the text, and outputs another type of sound on the basis of an analysis result.

An example of the voice outputting apparatus may include a home robot of a home Internet of things (IoT) system or an artificial intelligence (AI) speaker equipped with an artificial intelligence technology.

Meanwhile, a user may control each voice outputting apparatus using a predetermined voice.

However, even if the corresponding voice outputting apparatus outputs a response regarding a voice, the response may not be properly transmitted to the user due to noise of the voice outputting apparatus itself, a distance between the voice outputting apparatus and a speaker, and noise around the voice outputting apparatus.

### SUMMARY OF THE INVENTION

The present invention aims at solving the above-mentioned necessity and/or problems.

The present invention provides an intelligent voice outputting method and apparatus and an intelligent computing device for accurately and effectively transferring a response regarding a voice to a voice speaker.

In an aspect, an intelligent voice outputting method includes: obtaining a voice from a microphone detection signal; capturing an image in a direction in which the microphone detection signal is received; obtaining a distance to a speaker of the voice on the basis of the microphone detection signal and the image; and outputting a response regarding the voice on the basis of the distance to the speaker.

The obtaining of the distance may include detecting a plurality of objects from the image; and analyzing the plurality of objects and the microphone detection signal to determine a speaker of the voice among the plurality of objects.

The determining of the speaker of the voice among the plurality of objects may include detecting the speaker of the voice by applying lip reading processing to the plurality of objects and the microphone detection signal.

The outputting of the response may include: setting an optimal TTS volume corresponding to the distance to the speaker; and outputting the response with the optimal TTS volume.

The setting of the optimal TTS volume may include: obtaining noise information around the voice outputting apparatus by analyzing the microphone detection signal; and setting the optimal TTS corresponding to the distance to the speaker and the noise information.

The setting of the optimal TTS volume may include: inputting the distance to the speaker and the noise information to an artificial neural network (ANN); and obtaining the optimal TTS volume as an output of the ANN.

The ANN may be trained in advance using a training set based on the distance and noise information as input values and a predetermined optimal TTS volume value as an output value.

The method may further include: receiving, from a network, a downlink control information (DCI) used to schedule transmission of the distance to the speaker and the noise information; and transmitting, to the network, the distance to the speaker and the noise information on the basis of downlink control information (DCI).

The method may further include: performing an initial access procedure with the network on the basis of a synchronization signal block (SSB); and transmitting, to the network, the distance to the speaker and the noise information via a physical uplink shared channel (PUSCH), wherein the SSB and a demodulation reference signal (DM-RS) of the PUSCH are quasi-co-located, QCL, for a QCL type D.

The method may further include: controlling a communication module to transmit the distance to the speaker and the noise information to an artificial intelligence (AI) processor included in the network; and controlling the communication module to receive AI-processed information from the AI processor, wherein the AI processed information may be an optimal TTS volume determined on the basis of the distance to the speaker and the noise information.

In another aspect, an intelligent voice outputting apparatus includes: a speaker; at least one microphone detecting an external signal; a camera capturing an image in a direction in which the microphone detection signal is received; and a processor obtaining a voice from the microphone detection signal, obtaining a distance to a speaker of the voice on the basis of the microphone detection signal and the image, and outputting a response regarding the voice through the speaker on the basis of the distance to the speaker.

The processor may detect the plurality of objects from the image and determine the speaker of the voice among the plurality of objects by analyzing the plurality of objects and the microphone detection signal.

The processor may detect the speaker of the voice by applying lip reading processing to the plurality of objects and the microphone detection signal.

The processor may set an optimal TTS volume corresponding to the distance to the speaker and output the response with the optimal TTS volume.

The processor may obtain noise information around the voice outputting apparatus by analyzing the microphone detection signal and set an optimal TTS volume corresponding to the distance to the speaker and the noise information.

The processor may input the distance to the speaker and the noise information to an artificial neural network (ANN) and obtain the optimal TTS volume as an output of the ANN.

The ANN may be trained in advance using a training set based on the distance and noise information as input values and a predetermined optimal TTS volume value as an output value.

The apparatus may further include: a communication module transmitting and receiving data to and from the outside, wherein the processor may receive, from a network, downlink control information (DCI) used to schedule transmission of the distance to the speaker and the noise information through the communication module and transmit, to the network, the distance to the speaker and the noise information on the basis of the DCI through the communication module.

The processor may perform an initial access procedure with the network on the basis of a synchronization signal block (SSB) through the communication module, and transmit, to the network, the distance to the speaker and the noise information via a physical uplink shared channel (PUSCH), wherein the SSB and a demodulation reference signal (DM-RS) of the PUSCH are quasi-co-located, QCL, for a QCL type D.

The processor may control the communication module to transmit the distance to the speaker and the noise information to an artificial intelligence (AI) processor included in the network and control the communication module to receive AI-processed information from the AI processor, wherein the AI-processed information may be an optimal TTS volume determined on the basis of the distance to the speaker and the noise information.

In another aspect, a non-transitory computer-readable recording medium, as a non-transitory computer-readable component storing a computer-executable component configured to be executed in one or more processors of a computing device, obtains a voice from a microphone detection signal, captures an image in a direction in which the microphone detection signal is received, obtains a distance to a speaker of the voice on the basis of the microphone detection signal and the image, and outputs a response regarding the voice on the basis of the distance to the speaker.

### BRIEF DESCRIPTION OF THE DRAWINGS

The accompanying drawings, which are included as part of the detailed description to help understand the present invention, provide an embodiment of the present invention and describe the technical features of the present invention together with the detailed description.

FIG. 1 shows a block diagram of a wireless communication system to which methods proposed in the disclosure are applicable.

FIG. 2 shows an example of a signal transmission/reception method in a wireless communication system.

FIG. 3 shows an example of basic operations of an user equipment and a 5G network in a 5G communication system.

FIG. 4 shows an example of a schematic block diagram in which a text-to-speech (TTS) method according to an embodiment of the present invention is implemented.

FIG. 5 shows a block diagram of an AI device that may be applied to one embodiment of the present invention.

FIG. 6 shows an exemplary block diagram of a voice outputting apparatus according to an embodiment of the present invention.

FIG. 7 shows a schematic block diagram of a text-to-speech (TTS) device in a TTS system according to an embodiment of the present invention.

FIG. 8 shows a schematic block diagram of a TTS device in a TTS system environment according to an embodiment of the present invention.

FIG. 9 is a schematic block diagram of an AI processor capable of performing emotion classification information-based TTS according to an embodiment of the present invention.

FIG. 10 illustrates an example of a voice outputting system according to an embodiment of the present invention.

FIG. 11 is a flowchart illustrating an intelligent voice outputting method of a voice outputting apparatus according to an embodiment of the present invention.

FIG. 12 is a flowchart illustrating a step of obtaining a distance to a speaker (step S150 of FIG. 11).

FIG. 13 illustrates an example of a step of detecting a plurality of persons (step S151 of FIG. 12).

FIG. 14 illustrates an example of a step of determining a voice speaker (steps S153 and S155 of FIG. 12).

FIG. 15 illustrates an example of a step of estimating a distance to the speaker (step S157 of FIG. 12).

FIG. 16 is a flowchart illustrating a process of performing a response output step (step S170 of FIG. 11) using AI processing.

FIG. 17 is a flowchart illustrating a process of performing a response output step (S170 of FIG. 11) using a 5G network.

FIG. 18 illustrates different examples of outputting responses with different optimal TTS volume values.

### DESCRIPTION OF EXEMPLARY EMBODIMENTS

Hereinafter, embodiments of the disclosure will be described in detail with reference to the attached drawings. The same or similar components are given the same reference numbers and redundant description thereof is omitted. The suffixes “module” and “unit” of elements herein are used for convenience of description and thus can be used interchangeably and do not have any distinguishable meanings or functions. Further, in the following description, if a detailed description of known techniques associated with the present invention would unnecessarily obscure the gist of the present invention, detailed description thereof will be omitted. In addition, the attached drawings are provided for easy understanding of embodiments of the disclosure and do not limit technical spirits of the disclosure, and the embodiments should be construed as including all modifications, equivalents, and alternatives falling within the spirit and scope of the embodiments.

While terms, such as “first”, “second”, etc., may be used to describe various components, such components must not be limited by the above terms. The above terms are used only to distinguish one component from another.

When an element is “coupled” or “connected” to another element, it should be understood that a third element may be present between the two elements although the element may be directly coupled or connected to the other element. When an element is “directly coupled” or “directly connected” to another element, it should be understood that no element is present between the two elements.

The singular forms are intended to include the plural forms as well, unless the context clearly indicates otherwise.

In addition, in the specification, it will be further understood that the terms “comprise” and “include” specify the presence of stated features, integers, steps, operations, elements, components, and/or combinations thereof, but do not preclude the presence or addition of one or more other features, integers, steps, operations, elements, components, and/or combinations.

Hereinafter, 5G communication (5th generation mobile communication) required by an apparatus requiring AI processed information and/or an AI processor will be described through paragraphs A through G.

A. Example of Block Diagram of UE and 5G Network

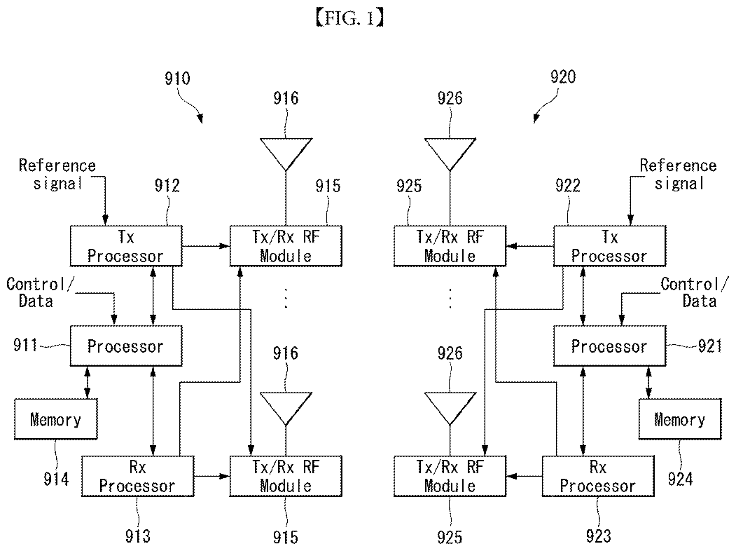

FIG. 1 is a block diagram of a wireless communication system to which methods proposed in the disclosure are applicable.

Referring to FIG. 1, a device (AI device) including an AI module is defined as a first communication device (910 of FIG. 1), and a processor 911 can perform detailed AI operation.

A 5G network including another device (AI server) communicating with the AI device is defined as a second communication device (920 of FIG. 1), and a processor 921 can perform detailed AI operations.

The 5G network may be represented as the first communication device and the AI device may be represented as the second communication device.

For example, the first communication device or the second communication device may be a base station, a network node, a transmission terminal, a reception terminal, a wireless device, a wireless communication device, an autonomous device, or the like.

For example, the first communication device or the second communication device may be a base station, a network node, a transmission terminal, a reception terminal, a wireless device, a wireless communication device, a vehicle, a vehicle having an autonomous function, a connected car, a drone (Unmanned Aerial Vehicle, UAV), and AI (Artificial Intelligence) module, a robot, an AR (Augmented Reality) device, a VR (Virtual Reality) device, an MR (Mixed Reality) device, a hologram device, a public safety device, an MTC device, an IoT device, a medical device, a Fin Tech device (or financial device), a security device, a climate/environment device, a device associated with 5G services, or other devices associated with the fourth industrial revolution field.

For example, a terminal or user equipment (UE) may include a cellular phone, a smart phone, a laptop computer, a digital broadcast terminal, personal digital assistants (PDAs), a portable multimedia player (PMP), a navigation device, a slate PC, a tablet PC, an ultrabook, a wearable device (e.g., a smartwatch, a smart glass and a head mounted display (HMD)), etc. For example, the HMD may be a display device worn on the head of a user. For example, the HMD may be used to realize VR, AR or MR. For example, the drone may be a flying object that flies by wireless control signals without a person therein. For example, the VR device may include a device that implements objects or backgrounds of a virtual world. For example, the AR device may include a device that connects and implements objects or background of a virtual world to objects, backgrounds, or the like of a real world. For example, the MR device may include a device that unites and implements objects or background of a virtual world to objects, backgrounds, or the like of a real world. For example, the hologram device may include a device that implements 360-degree 3D images by recording and playing 3D information using the interference phenomenon of light that is generated by two lasers meeting each other which is called holography. For example, the public safety device may include an image repeater or an imaging device that can be worn on the body of a user. For example, the MTC device and the IoT device may be devices that do not require direct interference or operation by a person. For example, the MTC device and the IoT device may include a smart meter, a bending machine, a thermometer, a smart bulb, a door lock, various sensors, or the like. For example, the medical device may be a device that is used to diagnose, treat, attenuate, remove, or prevent diseases. For example, the medical device may be a device that is used to diagnose, treat, attenuate, or correct injuries or disorders. For example, the medial device may be a device that is used to examine, replace, or change structures or functions. For example, the medical device may be a device that is used to control pregnancy. For example, the medical device may include a device for medical treatment, a device for operations, a device for (external) diagnose, a hearing aid, an operation device, or the like. For example, the security device may be a device that is installed to prevent a danger that is likely to occur and to keep safety. For example, the security device may be a camera, a CCTV, a recorder, a black box, or the like. For example, the Fin Tech device may be a device that can provide financial services such as mobile payment.

Referring to FIG. 1, the first communication device 910 and the second communication device 920 include processors 911 and 921, memories 914 and 924, one or more Tx/Rx radio frequency (RF) modules 915 and 925, Tx processors 912 and 922, Rx processors 913 and 923, and antennas 916 and 926. The Tx/Rx module is also referred to as a transceiver. Each Tx/Rx module 915 transmits a signal through each antenna 926. The processor implements the aforementioned functions, processes and/or methods. The processor 921 may be related to the memory 924 that stores program code and data. The memory may be referred to as a computer-readable medium. More specifically, the Tx processor 912 implements various signal processing functions with respect to L1 (i.e., physical layer) in DL (communication from the first communication device to the second communication device). The Rx processor implements various signal processing functions of L1 (i.e., physical layer).

UL (communication from the second communication device to the first communication device) is processed in the first communication device 910 in a way similar to that described in association with a receiver function in the second communication device 920. Each Tx/Rx module 925 receives a signal through each antenna 926. Each Tx/Rx module provides RF carriers and information to the Rx processor 923. The processor 921 may be related to the memory 924 that stores program code and data. The memory may be referred to as a computer-readable medium.

B. Signal Transmission/Reception Method in Wireless Communication System

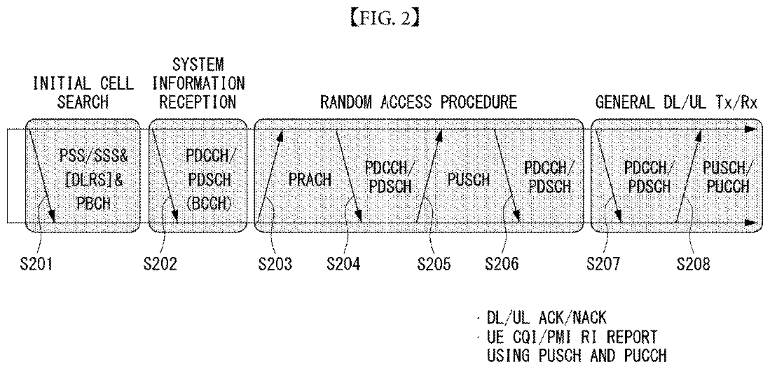

FIG. 2 is a diagram showing an example of a signal transmission/reception method in a wireless communication system.

Referring to FIG. 2, when a UE is powered on or enters a new cell, the UE performs an initial cell search operation such as synchronization with a BS (S201). For this operation, the UE can receive a primary synchronization channel (P-SCH) and a secondary synchronization channel (S-SCH) from the BS to synchronize with the BS and obtain information such as a cell ID. In LTE and NR systems, the P-SCH and S-SCH are respectively called a primary synchronization signal (PSS) and a secondary synchronization signal (SSS). After initial cell search, the UE can obtain broadcast information in the cell by receiving a physical broadcast channel (PBCH) from the BS. Further, the UE can receive a downlink reference signal (DL RS) in the initial cell search step to check a downlink channel state. After initial cell search, the UE can obtain more detailed system information by receiving a physical downlink shared channel (PDSCH) according to a physical downlink control channel (PDCCH) and information included in the PDCCH (S202).

Meanwhile, when the UE initially accesses the BS or has no radio resource for signal transmission, the UE can perform a random access procedure (RACH) for the BS (steps S203 to S206). To this end, the UE can transmit a specific sequence as a preamble through a physical random access channel (PRACH) (S203 and S205) and receive a random access response (RAR) message for the preamble through a PDCCH and a corresponding PDSCH (S204 and S206). In the case of a contention-based RACH, a contention resolution procedure may be additionally performed.

After the UE performs the above-described process, the UE can perform PDCCH/PDSCH reception (S207) and physical uplink shared channel (PUSCH)/physical uplink control channel (PUCCH) transmission (S208) as normal uplink/downlink signal transmission processes. Particularly, the UE receives downlink control information (DCI) through the PDCCH. The UE monitors a set of PDCCH candidates in monitoring occasions set for one or more control element sets (CORESET) on a serving cell according to corresponding search space configurations. A set of PDCCH candidates to be monitored by the UE is defined in terms of search space sets, and a search space set may be a common search space set or a UE-specific search space set. CORESET includes a set of (physical) resource blocks having a duration of one to three OFDM symbols. A network can configure the UE such that the UE has a plurality of CORESETs. The UE monitors PDCCH candidates in one or more search space sets. Here, monitoring means attempting decoding of PDCCH candidate(s) in a search space. When the UE has successfully decoded one of PDCCH candidates in a search space, the UE determines that a PDCCH has been detected from the PDCCH candidate and performs PDSCH reception or PUSCH transmission on the basis of DCI in the detected PDCCH. The PDCCH can be used to schedule DL transmissions over a PDSCH and UL transmissions over a PUSCH. Here, the DCI in the PDCCH includes downlink assignment (i.e., downlink grant (DL grant)) related to a physical downlink shared channel and including at least a modulation and coding format and resource allocation information, or an uplink grant (UL grant) related to a physical uplink shared channel and including a modulation and coding format and resource allocation information.

An initial access (IA) procedure in a 5G communication system will be additionally described with reference to FIG. 2.

The UE can perform cell search, system information acquisition, beam alignment for initial access, and DL measurement on the basis of an SSB. The SSB is interchangeably used with a synchronization signal/physical broadcast channel (SS/PBCH) block.

The SSB includes a PSS, an SSS and a PBCH. The SSB is configured in four consecutive OFDM symbols, and a PSS, a PBCH, an SSS/PBCH or a PBCH is transmitted for each OFDM symbol. Each of the PSS and the SSS includes one OFDM symbol and 127 subcarriers, and the PBCH includes 3 OFDM symbols and 576 subcarriers.

Cell search refers to a process in which a UE obtains time/frequency synchronization of a cell and detects a cell identifier (ID) (e.g., physical layer cell ID (PCI)) of the cell. The PSS is used to detect a cell ID in a cell ID group and the SSS is used to detect a cell ID group. The PBCH is used to detect an SSB (time) index and a half-frame.

There are 336 cell ID groups and there are 3 cell IDs per cell ID group. A total of 1008 cell IDs are present. Information on a cell ID group to which a cell ID of a cell belongs is provided/obtaind through an SSS of the cell, and information on the cell ID among 336 cell ID groups is provided/obtaind through a PSS.

The SSB is periodically transmitted in accordance with SSB periodicity. A default SSB periodicity assumed by a UE during initial cell search is defined as 20 ms. After cell access, the SSB periodicity can be set to one of {5 ms, 10 ms, 20 ms, 40 ms, 80 ms, 160 ms} by a network (e.g., a BS).

Next, acquisition of system information (SI) will be described.

SI is divided into a master information block (MIB) and a plurality of system information blocks (SIBs). SI other than the MIB may be referred to as remaining minimum system information. The MIB includes information/parameter for monitoring a PDCCH that schedules a PDSCH carrying SIB1 (SystemInformationBlock1) and is transmitted by a BS through a PBCH of an SSB. SIB1 includes information related to availability and scheduling (e.g., transmission periodicity and SI-window size) of the remaining SIBs (hereinafter, SIBx, x is an integer equal to or greater than 2). SiBx is included in an SI message and transmitted over a PDSCH. Each SI message is transmitted within a periodically generated time window (i.e., SI-window).

A random access (RA) procedure in a 5G communication system will be additionally described with reference to FIG. 2.

A random access procedure is used for various purposes. For example, the random access procedure can be used for network initial access, handover, and UE-triggered UL data transmission. A UE can obtain UL synchronization and UL transmission resources through the random access procedure. The random access procedure is classified into a contention-based random access procedure and a contention-free random access procedure. A detailed procedure for the contention-based random access procedure is as follows.

A UE can transmit a random access preamble through a PRACH as Msg1 of a random access procedure in UL. Random access preamble sequences having different two lengths are supported. A long sequence length 839 is applied to subcarrier spacings of 1.25 kHz and 5 kHz and a short sequence length 139 is applied to subcarrier spacings of 15 kHz, 30 kHz, 60 kHz and 120 kHz.

When a BS receives the random access preamble from the UE, the BS transmits a random access response (RAR) message (Msg2) to the UE. A PDCCH that schedules a PDSCH carrying a RAR is CRC masked by a random access (RA) radio network temporary identifier (RNTI) (RA-RNTI) and transmitted. Upon detection of the PDCCH masked by the RA-RNTI, the UE can receive a RAR from the PDSCH scheduled by DCI carried by the PDCCH. The UE checks whether the RAR includes random access response information with respect to the preamble transmitted by the UE, that is, Msg1. Presence or absence of random access information with respect to Msg1 transmitted by the UE can be determined according to presence or absence of a random access preamble ID with respect to the preamble transmitted by the UE. If there is no response to Msg1, the UE can retransmit the RACH preamble less than a predetermined number of times while performing power ramping. The UE calculates PRACH transmission power for preamble retransmission on the basis of most recent pathloss and a power ramping counter.

The UE can perform UL transmission through Msg3 of the random access procedure over a physical uplink shared channel on the basis of the random access response information. Msg3 can include an RRC connection request and a UE ID. The network can transmit Msg4 as a response to Msg3, and Msg4 can be handled as a contention resolution message on DL. The UE can enter an RRC connected state by receiving Msg4.

C. Beam Management (BM) Procedure of 5G Communication System

A BM procedure can be divided into (1) a DL MB procedure using an SSB or a CSI-RS and (2) a UL BM procedure using a sounding reference signal (SRS). In addition, each BM procedure can include Tx beam swiping for determining a Tx beam and Rx beam swiping for determining an Rx beam.

The DL BM procedure using an SSB will be described.

Configuration of a beam report using an SSB is performed when channel state information (CSI)/beam is configured in RRC_CONNECTED.
A UE receives a CSI-ResourceConfig IE including CSI-SSB-ResourceSetList for SSB resources used for BM from a BS. The RRC parameter “csi-SSB-ResourceSetList” represents a list of SSB resources used for beam management and report in one resource set. Here, an SSB resource set can be set as {SSBx1, SSBx2, SSBx3, SSBx4, . . . }. An SSB index can be defined in the range of 0 to 63.
The UE receives the signals on SSB resources from the BS on the basis of the CSI-SSB-ResourceSetList.
When CSI-RS reportConfig with respect to a report on SSBRI and reference signal received power (RSRP) is set, the UE reports the best SSBRI and RSRP corresponding thereto to the BS. For example, when reportQuantity of the CSI-RS reportConfig IE is set to ‘ssb-Index-RSRP’, the UE reports the best SSBRI and RSRP corresponding thereto to the BS.

When a CSI-RS resource is configured in the same OFDM symbols as an SSB and ‘QCL-TypeD’ is applicable, the UE can assume that the CSI-RS and the SSB are quasi co-located (QCL) from the viewpoint of ‘QCL-TypeD’. Here, QCL-TypeD may mean that antenna ports are quasi co-located from the viewpoint of a spatial Rx parameter. When the UE receives signals of a plurality of DL antenna ports in a QCL-TypeD relationship, the same Rx beam can be applied.

Next, a DL BM procedure using a CSI-RS will be described.

An Rx beam determination (or refinement) procedure of a UE and a Tx beam swiping procedure of a BS using a CSI-RS will be sequentially described. A repetition parameter is set to ‘ON’ in the Rx beam determination procedure of a UE and set to ‘OFF’ in the Tx beam swiping procedure of a BS.

First, the Rx beam determination procedure of a UE will be described.
The UE receives an NZP CSI-RS resource set IE including an RRC parameter with respect to ‘repetition’ from a BS through RRC signaling. Here, the RRC parameter ‘repetition’ is set to ‘ON’.
The UE repeatedly receives signals on resources in a CSI-RS resource set in which the RRC parameter ‘repetition’ is set to ‘ON’ in different OFDM symbols through the same Tx beam (or DL spatial domain transmission filters) of the BS.
The UE determines an RX beam thereof.
The UE skips a CSI report. That is, the UE can skip a CSI report when the RRC parameter ‘repetition’ is set to ‘ON’.

Next, the Tx beam determination procedure of a BS will be described.
A UE receives an NZP CSI-RS resource set IE including an RRC parameter with respect to ‘repetition’ from the BS through RRC signaling. Here, the RRC parameter ‘repetition’ is related to the Tx beam swiping procedure of the BS when set to ‘OFF’.
The UE receives signals on resources in a CSI-RS resource set in which the RRC parameter ‘repetition’ is set to ‘OFF’ in different DL spatial domain transmission filters of the BS.
The UE selects (or determines) a best beam.
The UE reports an ID (e.g., CRI) of the selected beam and related quality information (e.g., RSRP) to the BS. That is, when a CSI-RS is transmitted for BM, the UE reports a CRI and RSRP with respect thereto to the BS.

Next, the UL BM procedure using an SRS will be described.
A UE receives RRC signaling (e.g., SRS-Config IE) including a (RRC parameter) purpose parameter set to ‘beam management” from a BS. The SRS-Config IE is used to set SRS transmission. The SRS-Config IE includes a list of SRS-Resources and a list of SRS-ResourceSets. Each SRS resource set refers to a set of SRS-resources.

The UE determines Tx beamforming for SRS resources to be transmitted on the basis of SRS-SpatialRelation Info included in the SRS-Config IE. Here, SRS-SpatialRelation Info is set for each SRS resource and indicates whether the same beamforming as that used for an SSB, a CSI-RS or an SRS will be applied for each SRS resource.
When SRS-SpatialRelationInfo is set for SRS resources, the same beamforming as that used for the SSB, CSI-RS or SRS is applied. However, when SRS-SpatialRelationlnfo is not set for SRS resources, the UE arbitrarily determines Tx beamforming and transmits an SRS through the determined Tx beamforming.

Next, a beam failure recovery (BFR) procedure will be described.

In a beamformed system, radio link failure (RLF) may frequently occur due to rotation, movement or beamforming blockage of a UE. Accordingly, NR supports BFR in order to prevent frequent occurrence of RLF. BFR is similar to a radio link failure recovery procedure and can be supported when a UE knows new candidate beams. For beam failure detection, a BS configures beam failure detection reference signals for a UE, and the UE declares beam failure when the number of beam failure indications from the physical layer of the UE reaches a threshold set through RRC signaling within a period set through RRC signaling of the BS. After beam failure detection, the UE triggers beam failure recovery by initiating a random access procedure in a PCell and performs beam failure recovery by selecting a suitable beam. (When the BS provides dedicated random access resources for certain beams, these are prioritized by the UE). Completion of the aforementioned random access procedure is regarded as completion of beam failure recovery.

D. URLLC (Ultra-Reliable and Low Latency Communication)

URLLC transmission defined in NR can refer to (1) a relatively low traffic size, (2) a relatively low arrival rate, (3) extremely low latency requirements (e.g., 0.5 and 1 ms), (4) relatively short transmission duration (e.g., 2 OFDM symbols), (5) urgent services/messages, etc. In the case of UL, transmission of traffic of a specific type (e.g., URLLC) needs to be multiplexed with another transmission (e.g., eMBB) scheduled in advance in order to satisfy more stringent latency requirements. In this regard, a method of providing information indicating preemption of specific resources to a UE scheduled in advance and allowing a URLLC UE to use the resources for UL transmission is provided.

NR supports dynamic resource sharing between eMBB and URLLC. eMBB and URLLC services can be scheduled on non-overlapping time/frequency resources, and URLLC transmission can occur in resources scheduled for ongoing eMBB traffic. An eMBB UE may not ascertain whether PDSCH transmission of the corresponding UE has been partially punctured and the UE may not decode a PDSCH due to corrupted coded bits. In view of this, NR provides a preemption indication. The preemption indication may also be referred to as an interrupted transmission indication.

With regard to the preemption indication, a UE receives DownlinkPreemption IE through RRC signaling from a BS. When the UE is provided with DownlinkPreemption IE, the UE is configured with INT-RNTI provided by a parameter int-RNTI in DownlinkPreemption IE for monitoring of a PDCCH that conveys DCI format 2_1. The UE is additionally configured with a corresponding set of positions for fields in DCI format 2_1 according to a set of serving cells and positionInDCI by INT-ConfigurationPerServing Cell including a set of serving cell indexes provided by servingCellID, configured having an information payload size for DCI format 2_1 according to dci-Payloadsize, and configured with indication granularity of time-frequency resources according to timeFrequencySect.

The UE receives DCI format 2_1 from the BS on the basis of the DownlinkPreemption IE.

When the UE detects DCI format 2_1 for a serving cell in a configured set of serving cells, the UE can assume that there is no transmission to the UE in PRBs and symbols indicated by the DCI format 2_1 in a set of PRBs and a set of symbols in a last monitoring period before a monitoring period to which the DCI format 2_1 belongs. For example, the UE assumes that a signal in a time-frequency resource indicated according to preemption is not DL transmission scheduled therefor and decodes data on the basis of signals received in the remaining resource region.

E. mMTC (massive MTC)

mMTC (massive Machine Type Communication) is one of 5G scenarios for supporting a hyper-connection service providing simultaneous communication with a large number of UEs. In this environment, a UE intermittently performs communication with a very low speed and mobility. Accordingly, a main goal of mMTC is operating a UE for a long time at a low cost. With respect to mMTC, 3GPP deals with MTC and NB (NarrowBand)-IoT.

mMTC has features such as repetitive transmission of a PDCCH, a PUCCH, a PDSCH (physical downlink shared channel), a PUSCH, etc., frequency hopping, retuning, and a guard period.

That is, a PUSCH (or a PUCCH (particularly, a long PUCCH) or a PRACH) including specific information and a PDSCH (or a PDCCH) including a response to the specific information are repeatedly transmitted. Repetitive transmission is performed through frequency hopping, and for repetitive transmission, (RF) retuning from a first frequency resource to a second frequency resource is performed in a guard period and the specific information and the response to the specific information can be transmitted/received through a narrowband (e.g., 6 resource blocks (RBs) or 1 RB).

F. Basic Operation of AI Processing Using 5G Communication

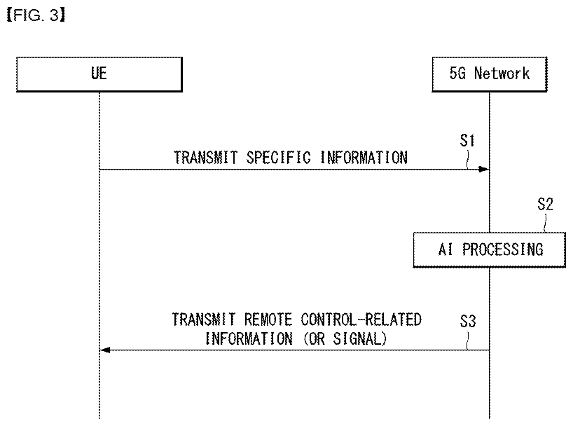

FIG. 3 shows an example of basic operations of AI processing in a 5G communication system.

The UE transmits specific information to the 5G network (S1). The 5G network may perform 5G processing related to the specific information (S2). Here, the 5G processing may include AI processing. And the 5G network may transmit response including AI processing result to UE(S3).

G. Applied Operations Between UE and 5G Network in 5G Communication System

Hereinafter, the operation of an autonomous vehicle using 5G communication will be described in more detail with reference to wireless communication technology (BM procedure, URLLC, mMTC, etc.) described in FIGS. 1 and 2.

First, a basic procedure of an applied operation to which a method proposed by the present invention which will be described later and eMBB of 5G communication are applied will be described.

As in steps S1 and S3 of FIG. 3, the autonomous vehicle performs an initial access procedure and a random access procedure with the 5G network prior to step S1 of FIG. 3 in order to transmit/receive signals, information and the like to/from the 5G network.

More specifically, the autonomous vehicle performs an initial access procedure with the 5G network on the basis of an SSB in order to obtain DL synchronization and system information. A beam management (BM) procedure and a beam failure recovery procedure may be added in the initial access procedure, and quasi-co-location (QCL) relation may be added in a process in which the autonomous vehicle receives a signal from the 5G network.

In addition, the autonomous vehicle performs a random access procedure with the 5G network for UL synchronization acquisition and/or UL transmission. The 5G network can transmit, to the autonomous vehicle, a UL grant for scheduling transmission of specific information. Accordingly, the autonomous vehicle transmits the specific information to the 5G network on the basis of the UL grant. In addition, the 5G network transmits, to the autonomous vehicle, a DL grant for scheduling transmission of 5G processing results with respect to the specific information. Accordingly, the 5G network can transmit, to the autonomous vehicle, information (or a signal) related to remote control on the basis of the DL grant.

Next, a basic procedure of an applied operation to which a method proposed by the present invention which will be described later and URLLC of 5G communication are applied will be described.

As described above, an autonomous vehicle can receive DownlinkPreemption IE from the 5G network after the autonomous vehicle performs an initial access procedure and/or a random access procedure with the 5G network. Then, the autonomous vehicle receives DCI format 2_1 including a preemption indication from the 5G network on the basis of DownlinkPreemption IE. The autonomous vehicle does not perform (or expect or assume) reception of eMBB data in resources (PRBs and/or OFDM symbols) indicated by the preemption indication. Thereafter, when the autonomous vehicle needs to transmit specific information, the autonomous vehicle can receive a UL grant from the 5G network.

Next, a basic procedure of an applied operation to which a method proposed by the present invention which will be described later and mMTC of 5G communication are applied will be described.

Description will focus on parts in the steps of FIG. 3 which are changed according to application of mMTC.

In step S1 of FIG. 3, the autonomous vehicle receives a UL grant from the 5G network in order to transmit specific information to the 5G network. Here, the UL grant may include information on the number of repetitions of transmission of the specific information and the specific information may be repeatedly transmitted on the basis of the information on the number of repetitions. That is, the autonomous vehicle transmits the specific information to the 5G network on the basis of the UL grant. Repetitive transmission of the specific information may be performed through frequency hopping, the first transmission of the specific information may be performed in a first frequency resource, and the second transmission of the specific information may be performed in a second frequency resource. The specific information can be transmitted through a narrowband of 6 resource blocks (RBs) or 1 RB.

The above-described 5G communication technology can be combined with methods proposed in the present invention which will be described later and applied or can complement the methods proposed in the present invention to make technical features of the methods concrete and clear.

H. Voice Output System and AI Processing

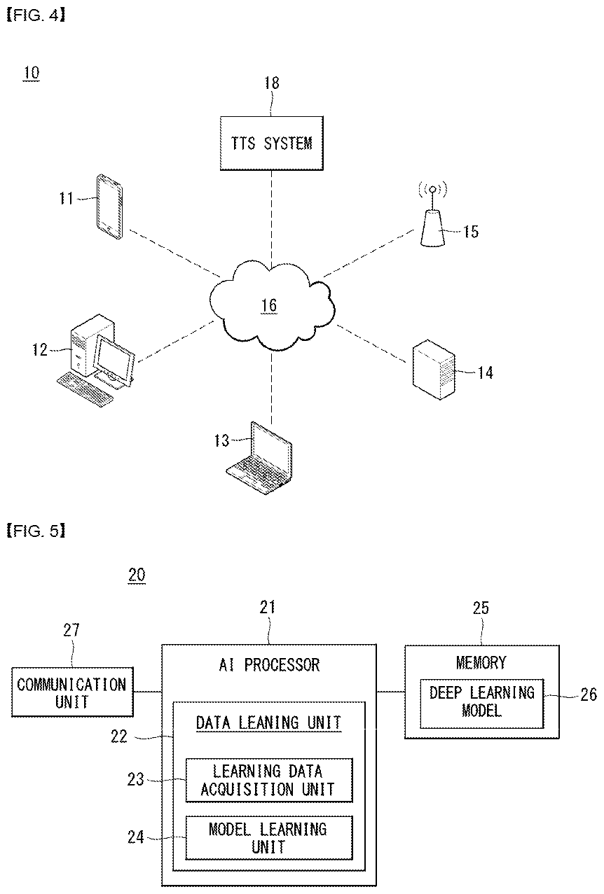

FIG. 4 illustrates a block diagram of a schematic system in which a voice output method is implemented according to an embodiment of the present invention.

Referring to FIG. 4, a system in which a voice output method is implemented according to an embodiment of the present invention may include as a voice output apparatus 10, a network system 16, and a text-to-to-speech (TTS) system as a speech synthesis engine.

The at least one voice output device 10 may include a mobile phone 11, a PC 12, a notebook computer 13, and other server devices 14. The PC12 and notebook computer 13 may connect to at least one network system 16 via a wireless access point 15. According to an embodiment of the present invention, the voice output apparatus 10 may include an audio book and a smart speaker.

Meanwhile, the TTS system 18 may be implemented in a server included in a network, or may be implemented by on-device processing and embedded in the voice output device 10. In the exemplary embodiment of the present invention, it is assumed that the TTS system 18 is implemented in the voice output device 10.

FIG. 5 shows a block diagram of an AI device that may be applied to one embodiment of the present invention.

The AI device 20 may include an electronic device including an AI module capable of performing AI processing or a server including the AI module. In addition, the AI device 20 may be included in at least a part of the voice output device 10 illustrated in FIG. 4 and may be provided to perform at least some of the AI processing together.

The AI processing may include all operations related to the voice output of the voice output device 10 shown in FIG. 5. For example, the AI processing may be a process of recognizing an optimal TTS volume value by analyzing distance information and noise information with a talker of the voice output apparatus 10.

The AI device 20 may include an AI processor 21, a memory 25, and/or a communication unit 27.

The AI device 20 is a computing device capable of learning neural networks, and may be implemented as various electronic devices such as a server, a desktop PC, a notebook PC, a tablet PC, and the like.

The AI processor 21 may learn a neural network using a program stored in the memory 25.

In particular, the AI processor 21 may learn a neural network for obtaining estimated noise information by analyzing the operating state of each voice output device. In this case, the neural network for outputting estimated noise information may be designed to simulate the human's brain structure on a computer, and may include a plurality of network nodes having weight and simulating the neurons of the human's neural network.

The plurality of network nodes can transmit and receive data in accordance with each connection relationship to simulate the synaptic activity of neurons in which neurons transmit and receive signals through synapses. Here, the neural network may include a deep learning model developed from a neural network model. In the deep learning model, a plurality of network nodes is positioned in different layers and can transmit and receive data in accordance with a convolution connection relationship. The neural network, for example, includes various deep learning techniques such as deep neural networks (DNN), convolutional deep neural networks(CNN), recurrent neural networks (RNN), a restricted boltzmann machine (RBM), deep belief networks (DBN), and a deep Q-network, and can be applied to fields such as computer vision, voice output, natural language processing, and voice/signal processing.

Meanwhile, a processor that performs the functions described above may be a general purpose processor (e.g., a CPU), but may be an AI-only processor (e.g., a GPU) for artificial intelligence learning.

The memory 25 can store various programs and data for the operation of the AI device 20. The memory 25 may be a nonvolatile memory, a volatile memory, a flash-memory, a hard disk drive (HDD), a solid state drive (SDD), or the like. The memory 25 is accessed by the AI processor 21 and reading-out/recording/correcting/deleting/updating, etc. of data by the AI processor 21 can be performed. Further, the memory 25 can store a neural network model (e.g., a deep learning model 26) generated through a learning algorithm for data classification/recognition according to an embodiment of the present invention.

Meanwhile, the AI processor 21 may include a data learning unit 22 that learns a neural network for data classification/recognition. The data learning unit 22 can learn references about what learning data are used and how to classify and recognize data using the learning data in order to determine data classification/recognition. The data learning unit 22 can learn a deep learning model by obtaining learning data to be used for learning and by applying the obtaind learning data to the deep learning model.

The data learning unit 22 may be manufactured in the type of at least one hardware chip and mounted on the AI device 20. For example, the data learning unit 22 may be manufactured in a hardware chip type only for artificial intelligence, and may be manufactured as a part of a general purpose processor (CPU) or a graphics processing unit (GPU) and mounted on the AI device 20. Further, the data learning unit 22 may be implemented as a software module. When the data leaning unit 22 is implemented as a software module (or a program module including instructions), the software module may be stored in non-transitory computer readable media that can be read through a computer. In this case, at least one software module may be provided by an OS (operating system) or may be provided by an application.

The data learning unit 22 may include a learning data obtaining unit 23 and a model learning unit 24.

The learning data obtatining unit 23 may acquire training data necessary for a neural network model for classifying and recognizing data. For example, the learning data obtatining unit 23 may acquire feature values extracted from distance information and noise information with a talker and/or distance information and noise information with a talker for input into a neural network model.

The learning data acquisition unit 23 may obtain training data for a neural network model for classifying and recognizing data. For example, the learning data acquisition unit 23 may obtain microphone detection signal to be input to the neural network model and/or a feature value, extracted from the message, as the training data.

The model learning unit 24 can perform learning such that a neural network model has a determination reference about how to classify predetermined data, using the obtaind learning data. In this case, the model learning unit 24 can train a neural network model through supervised learning that uses at least some of learning data as a determination reference. Alternatively, the model learning data 24 can train a neural network model through unsupervised learning that finds out a determination reference by performing learning by itself using learning data without supervision. Further, the model learning unit 24 can train a neural network model through reinforcement learning using feedback about whether the result of situation determination according to learning is correct. Further, the model learning unit 24 can train a neural network model using a learning algorithm including error back-propagation or gradient decent.

When a neural network model is learned, the model learning unit 24 can store the learned neural network model in the memory. The model learning unit 24 may store the learned neural network model in the memory of a server connected with the AI device 20 through a wire or wireless network.

The training data preprocessor may preprocess the obtained distance information and noise information with the talker so that the acquired distance information and noise information may be used for learning to recognize an optimal TTS volume value. For example, the training data preprocessor may use the acquired talker distance information and noise information in a preset format so that the model learner 24 may use the acquired training data for learning for optimal TTS volume value recognition.

In addition, the learning data selector may select data necessary for learning from the learning data acquired by the learning data obtaining unit 23 or the learning data preprocessed by the preprocessing unit. The selected training data may be provided to the model learner 24. For example, the training data selector detects a specific region among feature values of distance information and noise information with the talker obtained by the voice output apparatus 10, and selects only data for a syllable included in the specific region as the training data.

Further, the data learning unit 22 may further include a model estimator (not shown) to improve the analysis result of a neural network model.

The model estimator inputs estimation data to a neural network model, and when an analysis result output from the estimation data does not satisfy a predetermined reference, it can make the model learning unit 22 perform learning again. In this case, the estimation data may be data defined in advance for estimating a recognition model. For example, when the number or ratio of estimation data with an incorrect analysis result of the analysis result of a recognition model learned with respect to estimation data exceeds a predetermined threshold, the model estimator can estimate that a predetermined reference is not satisfied.

The communication unit 27 can transmit the AI processing result by the AI processor 21 to an external electronic device.

Here, the external electronic device may be defined as an autonomous vehicle. Further, the AI device 20 may be defined as another vehicle or a 5G network that communicates with the autonomous vehicle. Meanwhile, the AI device 20 may be implemented by being functionally embedded in an autonomous module included in a vehicle. Further, the 5G network may include a server or a module that performs control related to autonomous driving.

Meanwhile, the AI device 20 shown in FIG. 5 was functionally separately described into the AI processor 21, the memory 25, the communication unit 27, etc., but it should be noted that the aforementioned components may be integrated in one module and referred to as an AI module.

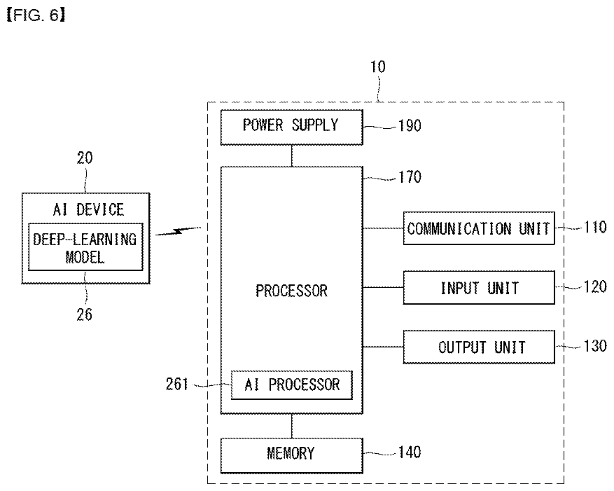

FIG. 6 is a block diagram of a voice outputting apparatus according to an embodiment of the present invention.

An embodiment of the present invention may include computer-readable and computer-executable instructions that may be included in the voice outputting apparatus 10. Although FIG. 6 discloses a plurality of components included in the voice outputting apparatus 10, components which are not disclosed in FIG. 6 may also be included in the voice outputting apparatus 10.

A plurality of voice outputting apparatuses may be applied to a single voice outputting apparatus. In such a multi-apparatus system, the voice outputting apparatus may include different components for performing various aspects of speech recognition processing. The voice outputting apparatus 10 illustrated in FIG. 6 is an example, may be an independent device, or may be implemented as a component of a larger device or system.

An embodiment of the present invention may be applied to a plurality of different devices and computer systems, for example, a general-purpose computing system, server-client computing system, telephone computing system, laptop computer, mobile terminal, PDA, tablet computer, and the like. The voice outputting apparatus 10 may also be applied as a component of another device or system providing a voice output function such as an automatic teller machine (ATM), kiosk, global positioning system (GPS), home appliance (e.g., refrigerator, oven, washing machine, etc.), vehicle, e-book reader, and the like.

As illustrated in FIG. 6, the voice outputting apparatus 10 may include a communication unit 110, an input unit 120, an output unit 130, a memory 140, a power supply unit 190, and/or a processor 170. Meanwhile, some of the components disclosed in the voice outputting apparatus 10, as single components, may appear several times in one device.

The voice outputting apparatus 10 may include an address/data bus (not shown) for transferring data between the components of the voice outputting apparatus 10. Each component in the voice outputting apparatus 10 may be directly connected to other components through the bus (not shown). Meanwhile, each component in the voice outputting apparatus 10 may also be directly connected to the processor 170.

The communication unit 110 may include a wireless communication device such as radio frequency (RF), infrared (Infrared), Bluetooth, wireless local area network (WLAN) (Wi-Fi, etc.), or a wireless network device such as a 5G network, long term evolution (LTE).), a network, a WiMAN network, a 3G network.

The input unit 120 may include a microphone, a touch input unit, a keyboard, a mouse, a stylus, or another input unit.

The output unit 130 may output information (e.g., voice) processed by the voice outputting apparatus 10 or another device. The output unit 130 may include a speaker, a headphone, or other suitable component for propagating voice. As another example, the output unit 130 may include an audio output unit. In addition, the output unit 130 may include a display (visual display or tactile display), an audio speaker, a headphone, a printer, or another output unit. The output unit 130 may be integrated with the voice outputting apparatus 10 or may be implemented separately from the voice outputting apparatus 10.

The input unit 120 and/or the output unit 130 may include an interface for connecting an external peripheral device such as universal serial bus (USB), FireWire, Thunderbolt, or another connection protocol. The input unit 120 and/or output unit 130 may include a network connection, such as an Ethernet port, a modem, or the like. The voice outputting apparatus 10 may be connected to the Internet or a distributed computing environment through the input unit 120 and/or the output unit 130. Also, the voice outputting apparatus 10 may be connected to a removable or external memory (e.g., a removable memory card, a memory key drive, a network storage, etc.) through the input unit 120 or the output unit 130.

The memory 140 may store data and commands. The memory 140 may include a magnetic storage, an optical storage, a solid-state storage type, and the like. The memory 140 may include a volatile RAM, a nonvolatile ROM, or other type of memory.

The voice outputting apparatus 10 may include a processor 170. The processor 170 may be connected to a bus (not shown), the input unit 120, the output unit 130, and/or other components of the voice outputting apparatus 10. The processor 170 may correspond to a CPU for processing data, a computer-readable instruction for processing data, and a memory for storing data and instructions.

Computer instructions to be processed in the processor 170 for operating the voice outputting apparatus 10 and various components may be executed by the processor 170 and may be stored in the memory 140 or in a memory or storage included in an external device or the processor 170 (to be described later). Alternatively, all or some of the executable instructions may be embedded in hardware or firmware in addition to software. An embodiment of the present invention may be implemented in various combinations of software, firmware and/or hardware, for example.

In detail, the processor 170 may process textual data into an audio waveform including voice or may process an audio waveform into textual data. A source of the textual data may be generated by an internal component of the voice outputting apparatus 10. Alternatively, the source of the textual data may be received from an input unit such as a keyboard or transmitted to the voice outputting apparatus 10 through a network connection. The text may be in the form of a sentence including text, numbers, and/or punctuation for conversion by the processor 170 into speech. The input text may also include a special annotation for processing by the processor 170 and may indicate how the specific text should be pronounced through the special annotation. The textual data may be processed in real time or stored and processed later.

In addition, although not shown in FIG. 6, the processor 170 may include a front end, a speech synthesis engine, and a TTS storage. The front end may convert input test data into symbolic linguistic representation for processing by the speech synthesis engine. The speech synthesis engine may convert the input text into speech by comparing annotated phonetic unit models with information stored in the TTS storage. The front end and the speech synthesis engine may include an embedded internal processor or memory or may use the processor 170 and the memory 140 included in the voice outputting apparatus 10. Instructions for operating the front end and the speech synthesis engine may be included in the processor 170, the memory 140 of the voice outputting apparatus 10, or an external device.

The text input to the processor 170 may be sent to the front end for processing. The front end may include a module for performing text normalization, linguistic analysis, and linguistic prosody generation.

During the text normalization operation, the front end processes the text input, generates standard text, and convert numbers, abbreviations, and symbols to the same ones as written.

The front end may generate a series of phonetic units corresponding to the input text by analyzing the language of the normalized text, while performing the linguistic analysis operation. This process may be called phonetic transcription.

The phonetic units are finally combined to include symbolic representations of sound units output by the voice outputting apparatus 10 as speech. Various sound units may be used to segment text for speech synthesis.

The processor 170 may process a voice on the basis of phonemes (individual sounds), half-phonemes, di-phones (a last half of one phoneme combined with a front half of an adjacent phoneme), bi-phones (two consecutive phonemes), syllables, words, phrases, sentences, or other units. Each word may be mapped to one or more phonetic units. Such mapping may be performed using a language dictionary stored in the voice outputting apparatus 10.

The linguistic analysis performed by the front end may include a process of identifying different grammatical elements such as prefixes, suffixes, phrases, punctuations, and syntactic boundaries. Such grammatical elements may be used by the processor 170 to produce natural audio waveform output. The language dictionary may also include letter-to-sound rules and other tools that may be used to pronounce previously unidentified words or letter combinations that may be generated by the processor 170. In general, as more information is included in the language dictionary, a voice output of higher quality may be guaranteed.

On the basis of the linguistic analysis, the front end may perform language rhythm generation annotated with prosodic characteristics indicating how the final acoustic unit should be pronounced in a final output speech on the phonetic units.

The rhyme characteristics may also be referred to as acoustic features. During the operation of this step, the front end may integrate into the processor 170 in consideration of certain prosodic annotations involving text input. Such acoustic features may include pitch, energy, duration, and the like. Application of the acoustic features may be based on prosodic models available to the processor 170.

Such a rhyme model indicates how phonetic units should be pronounced in certain situations. For example, a rhyme model may consider a phoneme's position in a syllable, a syllable's position in a word, or a word's position in a sentence or phrase, neighboring phonetic units, and the like. Like the language dictionary, as more information of the prosodic model is included, voice output of higher quality may be guaranteed.

The output of the front end may include a series of speech units annotated with prosodic characteristics. The output of the front end may be referred to as a symbolic linguistic representation. The symbolic linguistic representation may be sent to a speech synthesis engine.

The speech synthesis engine performs a process of converting a speech into an audio waveform for output to the user through the output unit 130. The speech synthesis engine may be configured to convert the input text into high quality natural speech in an efficient manner. Such high quality speech may be configured to be pronounced to be similar to a human speaker as much as possible.

The speech synthesis engine may perform speech synthesis using at least one or more other methods.

A unit selection engine compares a recorded speech database with a symbolic linguistic representation generated by the front end. The unit selection engine matches the symbol linguistic representation with a speech audio unit of the speech database. Matching units may be selected to form a speech output and the selected matching units may be connected together. Each unit may include an audio waveform corresponding to a phonetic unit such as a short .wav file of a specific sound together with a description of the various acoustic characteristics associated with a .wav file (pitch, energy, etc.). In addition, the phonetic unit may include other information such as a word, a sentence or a phrase, a position indicated in a neighboring phonetic unit.

The unit selection engine may match the input text by using all the information in a unit database to produce a natural waveform. The unit database may include an example of multiple speech units that provide different options to the voice outputting apparatus 10 to connect the units to speech. One of the advantages of unit selection is that natural voice output may be produced depending on the size of the database. In addition, as the unit database increases, the voice outputting apparatus 10 may configure a natural voice.

Meanwhile, there is a parametric synthesis method in addition to the unit selection synthesis described above. The parametric synthesis allows synthesis parameters such as frequency, volume and noise to be deformed by a parametric synthesis engine, a digital signal processor, or other audio generating device to produce an artificial speech waveform.

Parametric synthesis may match a symbolic linguistic representation to a desired output speech parameter using an acoustic model and various statistical techniques. The parametric synthesis not only processes speech without a large database associated with unit selection but also enables accurate processing at a high processing rate. The unit selection synthesis method and the parametric synthesis method may be performed separately or combined to generate a voice audio output.

The parametric speech synthesis may be performed as follows. The processor 170 may include an acoustic model capable of converting a symbolic linguistic representation into a synthetic acoustic waveform of a text input on the basis of audio signal operation. The acoustic model may include rules that may be used by the parametric synthesis engine to assign specific audio waveform parameters to input speech units and/or prosodic annotations. The rules may be used to calculate a score indicating a likelihood that a specific audio output parameter (frequency, volume, etc.) corresponds to a portion of the input symbolic linguistic representation from the front end.

The parametric synthesis engine may apply a plurality of techniques to match the voice to be synthesized with an input speech unit and/or a rhyme annotation. One of general techniques uses a hidden Markov model (HMM), which may be used to determine a probability that an audio output should be matched to the text input. The HMM may be used to convert parameters of language and acoustic space into parameters to be used by a vocoder (digital voice encoder) to artificially synthesize a desired speech.

In addition, the voice outputting apparatus 10 may include a speech unit database for use in unit selection. The speech unit database may be stored in the memory 140 or other storage component. The speech unit database may include recorded speech utterance. The speech utterance may be text corresponding to the speech content. In addition, the speech unit database may include recorded speech (in the form of audio waveforms, feature vectors or other formats) that occupies significant storage space in the voice outputting apparatus 10. Unit samples of the speech unit database may be classified in a variety of ways including speech units (phonemes, di-phones, words, etc.), linguistic rhyme labels, acoustic feature sequences, speaker identities, and the like. Sample utterance may be used to generate a mathematical model corresponding to a desired audio output for a specific speech unit.

When matching the symbolic linguistic representation, the speech synthesis engine may select a unit in the speech unit database that most closely matches the input text (including both speech units and rhythm symbol annotations). In general, as the speech unit database is larger, the number of selectable unit samples increases, thus enabling accurate speech output.

The processor 170 may transfer audio waveforms including audio output to the output unit 130 for output to the user. The processor 170 may store the audio waveforms including a speech in the memory 140 in a plurality of different formats such as a series of feature vectors, uncompressed audio data, or compressed audio data. For example, the processor 170 may encode and/or compress voice output using an encoder/decoder prior to the transmission. The encoder/decoder may encode and decode audio data such as digitized audio data, feature vectors, and the like. In addition, the functions of the encoder/decoder may be located in separate components or may be performed by the processor 170.

Meanwhile, the memory 140 may store other information for speech recognition. Content of the memory 140 may be prepared for general speech recognition and TTS use and may be customized to include sounds and words that are likely to be used in a specific application. For example, the TTS storage may include customized speech specialized for location and navigation for TTS processing by a GPS device.

The memory 140 may also be customized to the user on the basis of a personalized desired voice output. For example, a user may prefer a specific gender, a specific intonation, a specific rate, a specific emotion (e.g., a happy voice) in the output voice. The speech synthesis engine may include a specialized database or model to describe such user preferences.

The voice outputting apparatus 10 may also be configured to perform TTS processing in multiple languages. For each language, the processor 170 may include data, instructions, and/or components particularly configured to synthesize speech in a desired language.

The processor 170 may modify or update the contents of the memory 140 on the basis of feedback on a TTS processing result to improve performance, and thus, the processor 170 may enhance speech recognition more than power provided in a training corpus.

As the processing power of the voice outputting apparatus 10 is improved, voice output may be performed by reflecting an emotion attribute of the input text. Alternatively, even if the emotion attribute is not included in the input text, the voice outputting apparatus 10 may output a voice reflecting an intent (emotional information) of the user who created the input text.

When a model to be integrated into a TTS module that actually performs TTS processing is built, the TTS system may integrate the various components mentioned above with other components. For example, the voice outputting apparatus 10 may include a block for setting a speaker.

A speaker setting unit may set a speaker for each character appearing in a script. The speaker setting unit may be integrated into the processor 170 or may be integrated as part of the front end or the speech synthesis engine. The speaker setting unit synthesizes text corresponding to a plurality of characters into a speech of the speaker using metadata corresponding to a speaker profile.

According to an embodiment of the present invention, Markup Language may be used as the metadata, and preferably Speech Synthesis Markup Language (SSML) may be used.

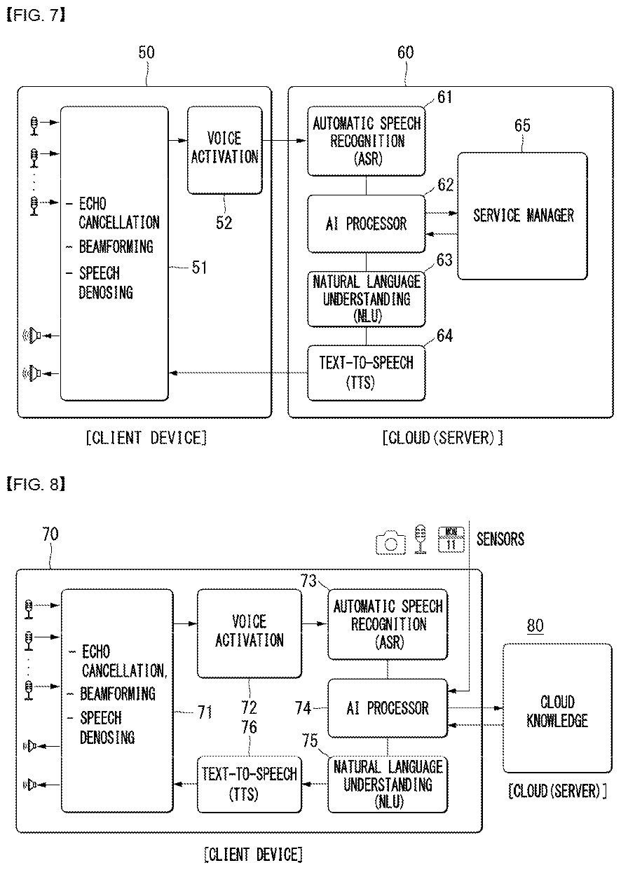

Described below with reference to FIGS. 7 and 8 is speech processing (speech recognition and speech output (TTS)) performed in a device environment and/or cloud environment or server environment. Referring to FIGS. 7 and 8, device environments 50 and 70 may be referred to as client devices, and cloud environments 60 and 80 may be referred to as servers. FIG. 7 illustrates an example in which, although speech input is performed by the device 50, the overall speech processing, e.g., processing input speech to thereby synthesize an output speech, is carried out in the cloud environment 60. In contrast, FIG. 8 illustrates an example of on-device processing by which the entire speech processing for processing input speech and synthesizing an output speech is performed by the device 70.

FIG. 7 is a block diagram schematically illustrating a voice outputting apparatus in a speech recognition system environment according to an embodiment of the present invention.

Speech event processing in an end-to-end speech UI environment requires various components. A sequence for processing a speech event includes gathering speech signals (signal acquisition and playback), speech pre-processing, voice activation, speech recognition, natural language processing, and speech synthesis which is the device's final step of responding to the user.

The client device 50 may include an input module. The input module my receive user input from the user. For example, the input module may receive user input from an external device (e.g., a keyboard or headset) connected thereto. For example, the input module may include a touchscreen. As an example, the input module may include hardware keys positioned in the user terminal.

According to an embodiment, the input module may include at least one microphone capable of receiving the user's utterances as voice signals. The input module may include a speech input system and receive user utterances as voice signals through the speech input system. The at least one microphone may generate input signals, thereby determining digital input signals for the user's utterances.

According to an embodiment, a plurality of microphones may be implemented as an array. The array may be configured in a geometrical pattern, e.g., a linear geometrical shape, a circular geometrical shape, or other various shapes. For example, four sensors may be arrayed in a circular shape around a predetermined point and be spaced apart from each other at 90 degrees to receive sounds from four directions. In some implementations, the microphones may include an array of sensors in different spaces for data communication, and an array of networked sensors may be included. The microphones may include omni-directional microphones or directional microphones (e.g., shotgun microphones).

The client device 50 may include a pre-processing module 51 capable of pre-processing user input (voice signals) received through the input module (e.g., microphones).

The pre-processing module 51 may have adaptive echo canceller (AEC) functionality, thereby removing echoes from the user input (voice signals) received through the microphones. The pre-processing module 51 may have noise suppression (NS) functionality, thereby removing background noise from the user input. The pre-processing module 51 may have end-point detect (EPD) functionality, thereby detecting the end point of the user's speech and hence discovering the portion where the user's voice is present. The pre-processing module 51 may have automatic gain control (AGC) functionality, thereby adjusting the volume of the user input to be suited for recognizing and processing the user input.

The client device 50 may include a voice activation module 52. The voice activation module 52 may recognize a wake-up command to recognize the user's invocation (e.g., a wake-up word). The voice activation module 52 may detect predetermined keywords (e.g., ‘Hi,’ or ‘LG’) from the user input which has undergone the pre-processing. The voice activation module 52 may stay idle and perform the functionality of always-on keyword detection.

The client device 50 may transmit the user voice input to the cloud server. Although core components of user speech processing, e.g.., automatic speech recognition (ASR), and natural language understanding (NLU), are typically performed by cloud due to, e.g., limited computing, storage, and power, embodiments of the present invention are not necessarily limited thereto, and such operations may also be performed by the client device 50 according to an embodiment.

The cloud may include a cloud device 60 for processing the user input received from the client. The cloud device 60 may be present in the form of a server.

The cloud device 60 may include an automatic speech recognition (ASR) module 61, an artificial intelligence agent 62, a natural language understanding (NLU) module 63, a text-to-speech (TTS) module 64, and a service manager 65.

The ASR module 61 may convert the user voice input received from the client device 50 into textual data.

The ASR module 61 includes a front-end speech pre-processor. The front-end speech processor extracts representative features from the speech input. For example, the front-end speech processor performs the Fourier transform on the speech input to thereby extracts a spectrum feature, which specifies the speech input, as a representative multi-dimensional vector sequence. The ASR module 61 may include one or more speech recognition models (e.g., acoustic models and/or linguistic models) and implement one or more speech recognition engines. Example speech recognition models include hidden Markov models, Gaussian-mixture models, deep neutral network models, n-gram linguistic models, and other statistical models.

Example speech recognition engines include dynamic time distortion-based engines and weighted finite state transducer (WFST)-based engines. One or more speech recognition models and one or more speech recognition engines may be used to process the representative features extracted by the front-end speech processor so as to generate intervening recognition results (e.g., phonemes, phoneme strings, and hyponyms), and ultimately text recognition results (e.g., words, word strings, or sequences of tokens).

If the ASR module 61 generates a recognition result including a text string (e.g., words, a sequence of words, or a sequence of tokens), the recognition result is transferred to the NLU module 63 for intent inference. In some examples, the ASR module 61 generate multiple candidate text representations of the speech input. Each candidate text representation is a sequence of words or tokens corresponding to the speech input.

The NLU module 63 may perform syntactic analysis or semantic analysis to grasp the users intent. The syntactic analysis may divide the user input into syntactic units (e.g., words, phrases, or morphemes) and figure out what syntactic components the syntactic units have. The semantic analysis may be performed using, e.g., semantic matching, rule matching, or formula matching. Thus, the NLU module 63 may obtain a domain, intent, or parameters necessary to represent the intent for the user input.

The NLU module 63 may determine the user's intent and parameters based on the matching rule which has been divided into the domain, intent, and parameters necessary to grasp the intent. For example, one domain (e.g., an alarm) may include a plurality of intents (e.g., set or release an alarm), and one intent may include a plurality of parameters (e.g., time, repetition count, or alarm sound). The plurality of rules may include, e.g., one or more essential element parameters. The matching rule may be stored in an natural language understanding (NLU) database (DB).

The NLU module 63 may grasp the meaning of a word extracted from the user input using linguistic features (e.g., syntactic elements) such as morphemes or phrases, match the grasped meaning of the word to the domain and intent, and determine the user's intent.

For example, the NLU module 63 may calculate how many words extracted from the user input are included in each domain and intent to thereby determine the user's intent. According to an embodiment, the NLU module 63 may determine the parameters of the user input using the word which is a basis for grasping the intent.

According to an embodiment, the NLU module 63 may determine the user's intent using the NLU DB storing the linguistic features for grasping the intent of the user input.

According to an embodiment, the NLU module 63 may determine the user's intent based on a personal language model (PLM). For example, the NLU module 63 may determine the user's intent using personal information (e.g., a contacts list, music list, schedule information, or social media information).

The personal language model may be stored in, e.g., the NLU DB. According to an embodiment, the ASR module 61, but not the NLU module 63 alone, may recognize the user's voice by referring to the personal language model stored in the NLU DB.

The NLU module 63 may further include a natural language generation module (not shown). The natural language generation module may convert designated information into text-type information. The text-type information may be in the form of a natural language utterance. The designated information may be, e.g., information about an additional input, information indicating that the operation corresponding to the user input is complete, or information indicating the user's additional input. The text-type information may be transmitted to the client device to be displayed on the display or may be transmitted to the TTS module to be converted into a speech.

The TTS module 64 may convert text-type information into speech-type information. The TTS module 63 may receive the text-type information from the natural language generation module of the NLG module 63, convert the text-type information into speech-type information, and send the speech-type information to the client device 50. The client device 50 may output the speech-type information via a speaker.

The speech synthesis module 64 synthesize a speech output based on the provided text. For example, the result generated by the ASR module 61 is in the form of a text string. The speech synthesis module 64 converts the text string into an audible speech output. The speech synthesis module 64 uses any adequate speech synthesis scheme to generate text into speech output, including, but not limited to, concatenative synthesis, unit selection synthesis, di-phone synthesis, domain-specific synthesis, formant synthesis, articulatory synthesis, hidden Markov model (HMM)-based synthesis, and sinewave synthesis.

In some examples, the speech synthesis module 64 is configured to synthesize individual words based on phoneme strings corresponding to words. For example, the phoneme strings are related to the words in the generated text string. The phoneme strings are stored in metadata related to the words. The speech synthesis module 64 is configured to directly process the phoneme strings in the metadata to synthesize words in the form of a speech.

Since cloud environments have more processing capability and resources than client devices, synthesis by clouds may actually present higher-quality of speech output that synthesis by clients. However, the present invention is not limited thereto, but speech synthesis may be performed by the client device (refer to FIG. 8).

According to an embodiment of the present invention, the cloud environment may further include an artificial intelligence (AI) processor (also referred to as an AI agent) 62. The AI processor 62 may be designed to perform at least some of the above-described functions of the ASR module 61, the NLU module 63, and/or the TTS module 64. The AI processor 62 may contribute to allowing the ASR module 61, the NLU module 63, and/or the TTS module 64 to perform their respective independent functions.

The AI processor 62 may perform the above-described functions via deep learning. Various research efforts (as to, e.g., how to create better representation schemes and, if created, how to learn such schemes) are underway to deep learning to represent some data in a computer-understandable form (e.g., representing image pixel information as column vectors) and apply the representation to learning and, thus, various deep learning schemes, such as deep neural networks (DNN), convolutional deep neural networks (CNN), recurrent Boltzmann machine (RNN), restricted Boltzmann machine (RBM), deep belief networks (DBN), and deep Q-network, are applicable to computer vision, speech recognition, natural language processing, voice/signal processing, or other various industry sectors.

All major commercial speech recognition systems, as of today, (e.g., MS Cortana, Skype translator, Google Now, Apple Siri, etc.) are based on deep learning.

The AI processor 62 may, among others, adopt the deep artificial neural network structure to carry out machine translation, emotion analysis, information retrieval, or other various types of natural language processing.

The cloud environment may include the service manager 65 which may gather various pieces of personal information and support the functions of the AI processor 62. The personal information obtained by the service manager may include at least one piece of data (e.g., calendar applications, message services, music applications) the client device 50 uses via the cloud environment, at least one piece of sensing data (e.g., data obtained by cameras, microphones, temperature, humidity, or gyro sensors, C-V2X, pulses, ambient light, or iris scans) gathered by the client device 50 and/or the cloud 60, and off-device data which are not directly related to the client device 50. For example, the personal information may include maps, SMS, news, music, stock, weather, or Wikipedia information.

Although the AI processor 62 is shown in a separate block distinguished from the ASR module 61, the NLU module 63, and TTS module 64 for illustration purposes, the AI processor 62 may perform all or at least some of the functions of each module 61, 62, and 64.

The AI processor 62 may perform at least some of the functions of the AI processors 21 and 261 described above in connection with FIGS. 5 and 6.

FIG. 8 is a block diagram schematically illustrating a voice outputting apparatus in a speech recognition system environment according to an embodiment of the present invention.

The client device 70 and cloud environment 80 of FIG. 8 may correspond to the client device 50 and cloud environment 60 of FIG. 7 except for differences in some components and functions. The description taken in conjunction with FIG. 7 may thus apply to specific functions of the corresponding blocks.

Referring to FIG. 8, the client device 70 may include a pre-processing module 71, a voice activation module 72, an ASR module 73, an AI processor 74, an NLU module 75, and a TTS module 76. The client device 70 may include an input module (at least one microphone) and at least one output module.

The cloud environment 80 may include a cloud knowledge storing personal information in the form of knowledge.

The description taken in conjunction with FIG. 7 may apply to the functions of each module of FIG. 8. However, as the ASR module 73, the NLU module 75, and the TTS module 76 are included in the client device 70, there is no need for communicating with the cloud for speech processing, e.g., speech recognition and speech synthesis, and immediate, real-time speech processing may thus be possible.

Each module shown in FIGS. 7 and 8 is merely an example for describing speech processing, and more or less modules than those shown in FIGS. 7 and 8 may be included. It should also be noted that two or more of the modules may be combined or different modules or different arrays of modules may be included. Various modules shown in FIGS. 7 and 8 may be implemented in one or more signal processing processors, application-specific integrated circuits (ASICs), hardware, software instructions executed by one or more processors, firmware, or combinations thereof.

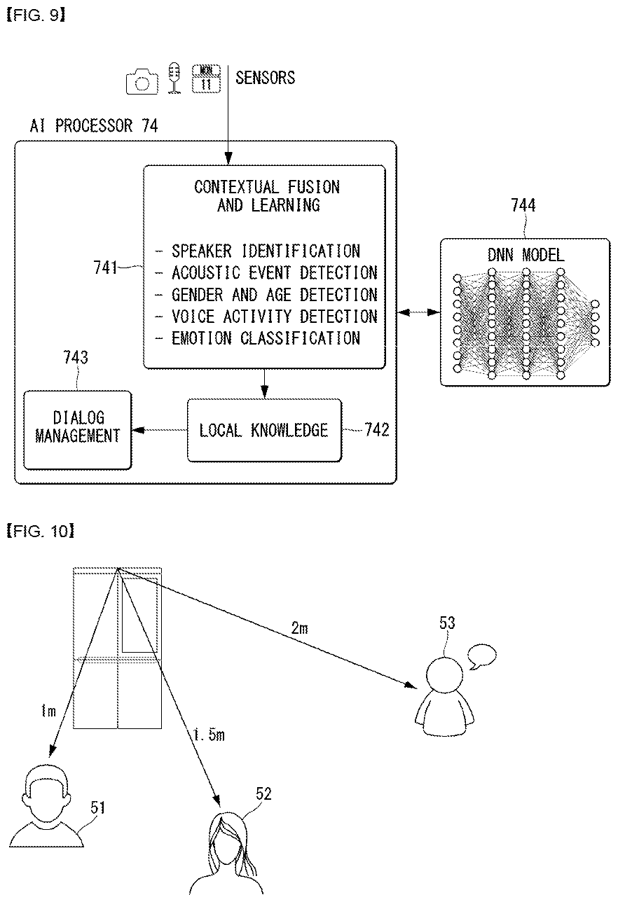

FIG. 9 illustrates a schematic block diagram of an intelligent processor capable of implementing voice output according to an embodiment of the present invention.

Referring to FIG. 9, in addition to performing the ASR operation, the NLU operation, and the TTS operation in the voice processing described above with reference to FIGS. 7 and 8, the intelligent processor 74 may support an interactive operation with the user. Alternatively, the intelligent processor 74 may contribute to an operation performed by the NLU module 63 of FIG. 7 to clarify and supplementarily or additionally define information included in the text representations received from the ASR module 61 using context information.

Here, the context information may include preference of a client device user, hardware and/or software states of the client device, various sensor information collected before, during, or immediately after a user input, previous interactions (e.g., dialogue) between the intelligent processor and the user, and the like. Of course, the context information in this document is dynamic and varies depending on time, location, content of a dialogue, and other factors.

The intelligent processor 74 may further include a context fusion and learning module 741, a local knowledge 742, and a dialog management 743.

The context fusion and learning module 741 may learn an intent of the user on the basis of at least one data. The at least one data may include at least one sensing data obtained from a client device or a cloud environment. Further, the at least one data may include speaker identification, acoustic event detection, personal information (gender and age detection) of a speaker, voice activity detection (VAD), and emotion information (emotion classification).

The speaker identification may refer to specifying a person who speaks in a registered conversation group by voice. The speaker identification may include a process of identifying a registered speaker or registering a new speaker. Acoustic event detection may detect a sound itself to recognize a type of the sound and a place where the sound is generated, beyond speech recognition technology. Voice activity detection (VAD) is a speech processing technique to detect the presence or absence of human speech (voice) from an audio signal that may include music, noise or other sound. According to an example, the intelligent processor 74 may determine the presence or absence of speech from the input audio signal. According to an example, the intelligent processor 74 may distinguish between speech data from non-speech data using a deep neural network (DNN) model. In addition, the intelligent processor 74 may perform an emotion classification operation on speech data using the DNN model. According to the emotion classification operation, the speech data may be classified into anger, boredom, fear, happiness, and sadness.

The context fusion and learning module 741 may include a DNN model in order to perform the above-described operation and determine an intent of the user input on the basis of the sensing information collected in the DNN model and the client device or the cloud environment.

The at least one data is merely illustrative and may include any data that may be referred to for determining the intent of the user in the voice processing process. Of course, the at least one data may be obtained through the above-described DNN model.

The intelligent processor 74 may include the local knowledge 742. The local knowledge 742 may include user data. The user data may include a user's preference, a user address, a user's initial set language, a user's contact list, and the like. According to an example, the intelligent processor 74 may additionally define the intent of the user by supplementing information included in a user's voice input using specific information of the user. For example, in response to a user's request of “Invite my friends to my birthday party,” the intelligent processor 74 may use the local knowledge 742, instead of requesting the user to provide clear information, to determine who are “friends” and when and where the “birthday party” is held.

The intelligent processor 74 may further include a dialog management 743. The intelligent processor 74 may provide a dialog interface to enable a voice conversation with a user. The dialog interface may refer to a process of outputting a response regarding the voice input of the user through a display or a speaker. Here, a final outcome output through the dialog interface may be based on the ASR operation, NLU operation, and TTS operation described above.

I. Voice Outputting Method of Present Invention

Meanwhile, according to the related art, most voice outputting apparatuses are inconvenient in that a volume of a response (TTS) is fixed regardless of distance between the user and the voice outputting apparatus or the user must manually adjust a volume size.

In order to solve the shortcomings, a distance measurement technology based on speech utterance recognized using a microphone array of the existing technology receives a lot of spatial characteristics, so it is easy to measure a relative distance but too vulnerable to measure an absolute distance measurement.

Further, distance measurement itself may be impossible depending on a noise situation and a reverberation situation of the voice outputting system.

Hereinafter, a voice outputting method according to an embodiment of the present invention for solving the above problems will be described in detail with reference to FIGS. 10 to 18.

FIG. 10 illustrates an example of a voice outputting system according to an embodiment of the present invention.

As illustrated in FIG. 10, the voice outputting apparatus 10 may be an IoT apparatus but is not necessarily limited thereto. Any apparatus capable of recognizing voice and outputting a response regarding the voice may be the voice outputting apparatus 10.

The voice outputting apparatus 10 may output a response regarding a voice spoken by a speaker 53 in a large or small manner in consideration of a distance to the speaker 53, and details thereof are as follows.

First, the voice outputting apparatus 10 may obtain a voice of the speaker 53. Here, the voice may be a wakeup word or a command spoken by the speaker 53. The voice may be obtained from a result of recognizing a microphone detection signal detected through at least one microphone (e.g., the input unit 120) of the voice outputting apparatus 10. The voice outputting apparatus 10 may recognize the voice from the microphone detection signal through a speech recognition activation module or an automatic speech recognition module of the voice outputting apparatus 10.

Next, the voice outputting apparatus 10 may capture an image of a direction in which the microphone detection signal is received by using the camera (e.g., the input unit 120) of the voice outputting apparatus 10 to determine a distance to the speaker 53.

Thereafter, the voice output apparatus 10 may detect a plurality of persons in the image by analyzing the image. Thereafter, the voice output apparatus 10 may determine the speaker 53 among the plurality of persons by applying a lip reading technique to face regions of the plurality of persons detected in the image and the microphone detection signal.

Subsequently, the voice outputting apparatus 10 may determine a distance to the speaker 53 among the plurality of people 51, 52, and 53 by using a distance estimation algorithm, and determine the distance to the speaker 53 as 2 m as a result of determination.

Finally, the voice outputting apparatus 10 may set an optimal TTS (response) volume value so that a response regarding the voice may be properly transmitted to the speaker 53 at the distance of 2 m, and output the response with the set optimal TTS volume value through the speaker (e.g., the output unit 110).

FIG. 11 is a flowchart illustrating an intelligent voice outputting method of a voice outputting apparatus according to an embodiment of the present invention.

As illustrated in FIG. 11, a processor (e.g., the AI processor 21 of FIG. 5 or the processor 170 of FIG. 6) of the voice outputting apparatus 10 may perform the voice outputting method S100 of FIG. 11, and details thereof are as follows. In the following description, the processor is assumed to be the processor 170 of FIG. 6 but is not necessarily limited thereto. The AI processor 21 of FIG. 5 may also perform the steps described below.

First, the processor 170 may obtain a voice from a microphone detection signal detected through at least one microphone (e.g., the input unit 120) (S110).

Here, the process of obtaining the voice from the microphone detection signal may be performed using the voice activation module 52 or 72 or the automatic speech recognition module 61 or 73 described above with reference to FIGS. 7 and 8.

Next, the processor 170 may recognize a direction in which the microphone detection signal is received, and capture an image of a direction in which the microphone detection signal is received by using a camera (e.g., the input unit 120) (S130).

For example, after obtaining the microphone detection signal, the processor 170 may recognize the direction in which the microphone detection signal is received by analyzing a phase difference of the signal detected by the at least one microphone. Subsequently, the processor 170 may change an image capture angle of the camera to the direction in which the microphone detection signal is received in order to capture an image of the direction in which the microphone detection signal is received.

Subsequently, the processor 170 may obtain a distance to the speaker of the voice on the basis of the microphone detection signal and the image (S150).

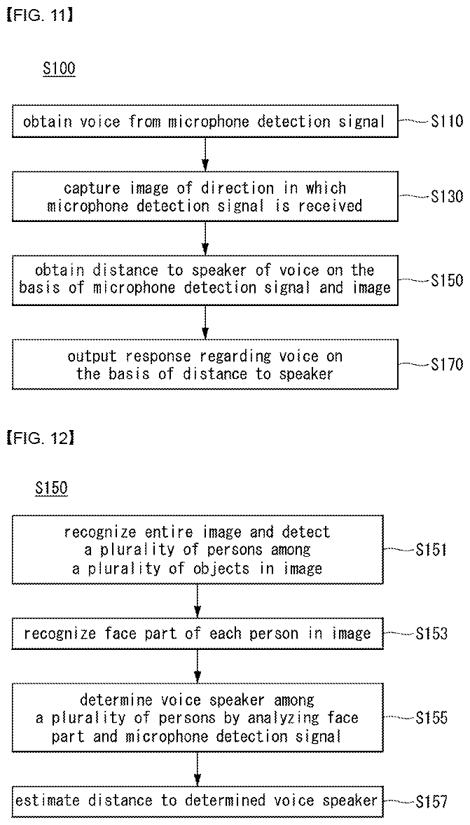

A method of obtaining the distance from the speaker of the voice will be described later with reference to FIGS. 12 to 15.

Subsequently, the processor 170 may output a response (or TTS) to the voice on the basis of the distance to the speaker (S170).

For example, in order to enable a speaker away by a certain distance to hear a response regarding the voice properly, the processor 170 may generates a response related to the voice on the basis of the distance to the speaker, set an optimal response (TTS) volume value for outputting the response, and output the response with the set optimal response volume value through the speaker (e.g., the output unit 110).

Here, the processor 170 may obtain noise information included in the microphone detection signal and set the optimal response volume value by reflecting noise information.

FIG. 12 is a flowchart specifically illustrating the step of obtaining the distance to the speaker (step S150 of FIG. 11).

As illustrated in FIG. 12, the processor 170 may detect a plurality of persons from among a plurality of objects in an image by recognizing the entire image obtained in step S130 (image capturing step) of FIG. 11.

For example, the processor 170 may detect a plurality of persons through a person detection processing process for the entire image area.

Subsequently, the processor 170 may recognize a face part of each person in the image (S153).

For example, the processor 170 may recognize the face part of each person in the image by using a previously learned face area detection model.

Thereafter, the processor 170 may analyze both the face part of the image and the microphone detection signal to determine a speaker of the voice among the plurality of persons in the image (S155).

In the process of determining the speaker of the voice from among the plurality of persons by using the face part of the image and the microphone detection signal, the processor 170 may determine the voice speaker through lip reading processing, and details thereof will be described later with reference to FIG. 14.

Finally, the processor 170 may estimate a distance from the determined speaker of the voice to the voice outputting apparatus 10 (S157).

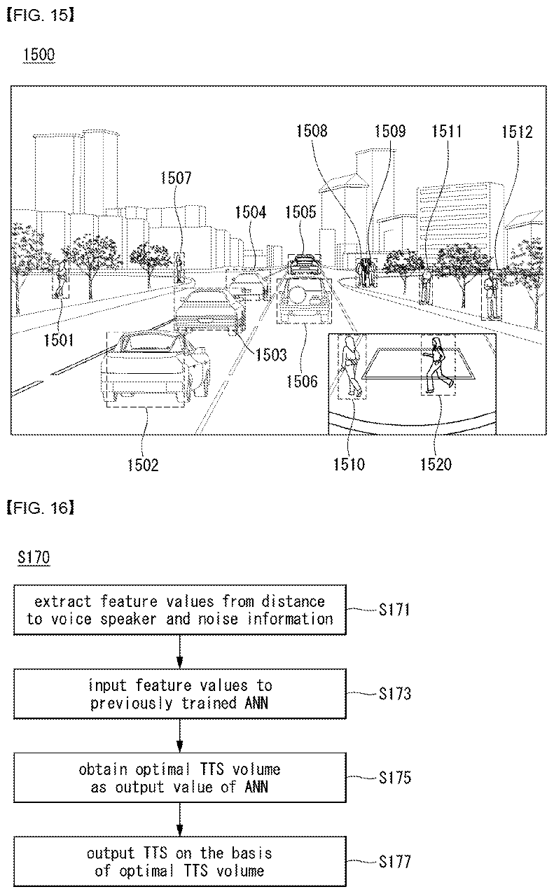

For example, the processor 170 may estimate the distance from the voice speaker to the voice outputting apparatus through a distance estimation algorithm, and details thereof will be described later with reference to FIG. 15.

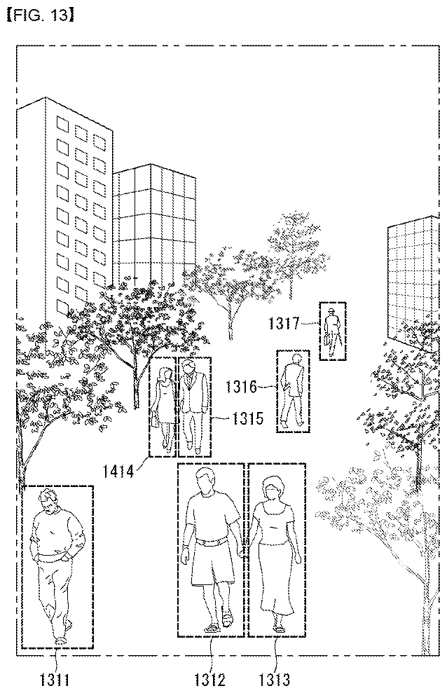

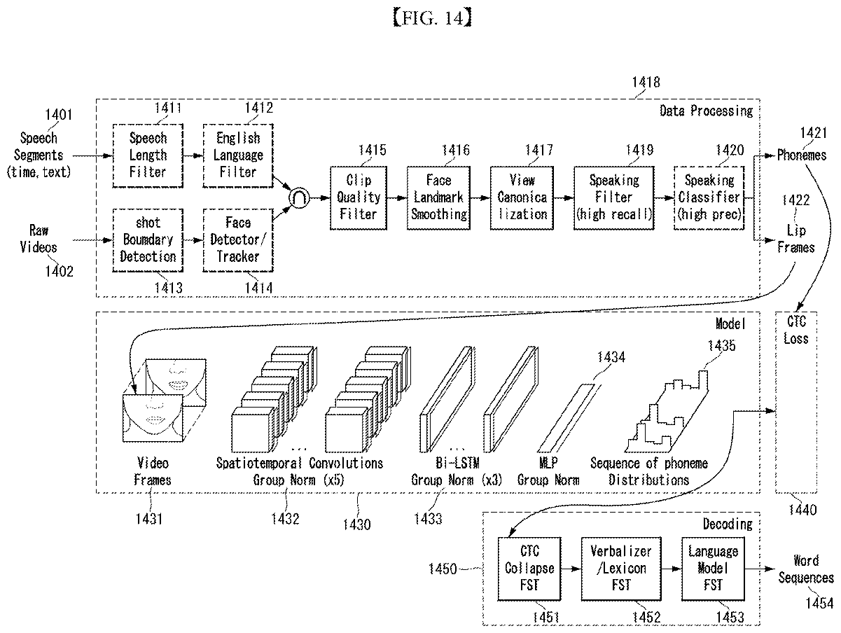

FIG. 13 illustrates an example of detecting a plurality of persons (step S151 of FIG. 12).

As illustrated in FIG. 13, the processor 170 may capture and obtain an image 1310 of a direction in which the microphone detection signal is received (or a microphone detection direction) by controlling the camera.

Subsequently, the processor 170 may detect only a plurality of persons 1311, 1312, 1313, 1314, 1315, 1316, and 1317 among the plurality of objects included in the image 1310 through an image processing process.

FIG. 14 illustrates an example of determining a voice speaker (steps S153 and S155 of FIG. 12).

As illustrated in FIG. 14, the processor 170 may determine a voice speaker using a microphone detection signal 1401 (speech segments) and an image 1402 (raw videos).

First, the processor 170 may generate integrated data by combining a result of applying a segment length filter 1411 and an English language filter 1412 to the microphone detection signal 1401 and a result of applying a slot boundary detection 1413 and a face detector/tracker 1414 to the image 1402.

Subsequently, the processor 170 may obtain phonemes 1421 and lip frames 1422 by applying a clip quality filter 1415, a face landmark smoothing 1416, a view canonicalization 1417, a speaking filter 1419, and a speaking classifier 1420 to the integrated data. Here, the process of 1415 to 1422 may be referred to as data processing 1418.

Subsequently, the processor 170 may input the phonemes 1421 to a CTC loss 1440. Meanwhile, the processor 170 converts the lip frames 1422 into video frames 1431, into spatiotemporal convolutions group norm 1432, into bi-LSTM group norm 1433, and into MLP group norm 1434, and into sequence of phoneme distributions 1435 through a modeling process 1430, so as to be input to the CTC loss 1440.

Subsequently, the processor 170 may obtain word sequences 1454 by applying a decoding process 1450 including a process of CTC collapse FST 1145, verbalizer/lexicon FST 1452, and language model FST 1450 to the result of application to the CTC Loss 1440.

Finally, the processor 170 may determine a speaker using a word sequence 1454.

FIG. 15 illustrates an example of a step of estimating the distance to the speaker (step S157 of FIG. 12).

As illustrated in FIG. 15, the processor 170 may capture an image 1500 of a direction in which the microphone detection signal is received.

Next, the processor 170 performs image processing on the entire area of the captured image 1500 to detect a plurality of persons 1501, 1507, 1508, 1509, 1511, and 1512 among the plurality of objects 1510 (1501, 1502, 1503, 1504, 1505, 1506, 1507, 1508, 1509, 1511, and 1512) present in the entire area.

Thereafter, the processor 170 may determine a speaker 1520 of the corresponding voice through image processing on the face part area of each of the persons 1501, 1507, 1508, 1509, 1511, and 1512 in the image through the lip reading technology described above with reference to FIG. 14.

Thereafter, the processor 170 may estimate a distance to the determined voice speaker 1520 using a distance estimation algorithm.

FIG. 16 is a flowchart illustrating a process of performing a response output step (step S170 of FIG. 11) using AI processing.

As illustrated in FIG. 16, the processor 170 may set an optimal TTS volume value and output a TTS through steps S170 (S171, S173, S175, and S177). Details thereof are as follows.

First, the processor 170 may extract a feature value from distance information to the speaker and noise information (S171).

For example, the processor 170 may perform a preprocessing process on the distance information to the speaker and the noise information and extract feature values (feature vectors) of the pre-processed distance information to the speaker and the noise information.

Subsequently, the processor 170 may input the extracted feature values of the distance information and the noise information to an artificial neural network (ANN) (S173).

Here, the ANN may be trained in advance to receive the feature values of the distance information to the speaker and the noise information as an input value and output an optimal TTS volume value as an output value thereof.

Subsequently, the processor 170 may obtain an optimal TTS volume value as an output value of the ANN (S175).

Thereafter, the processor 170 may output a TTS, which is a response related to voice, on the basis of the optimal TTS volume value (S177).

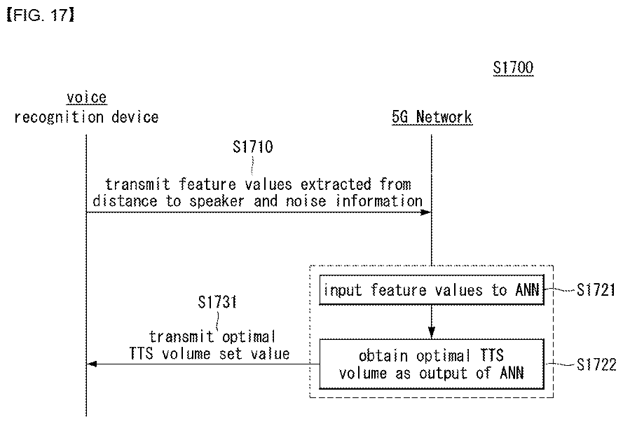

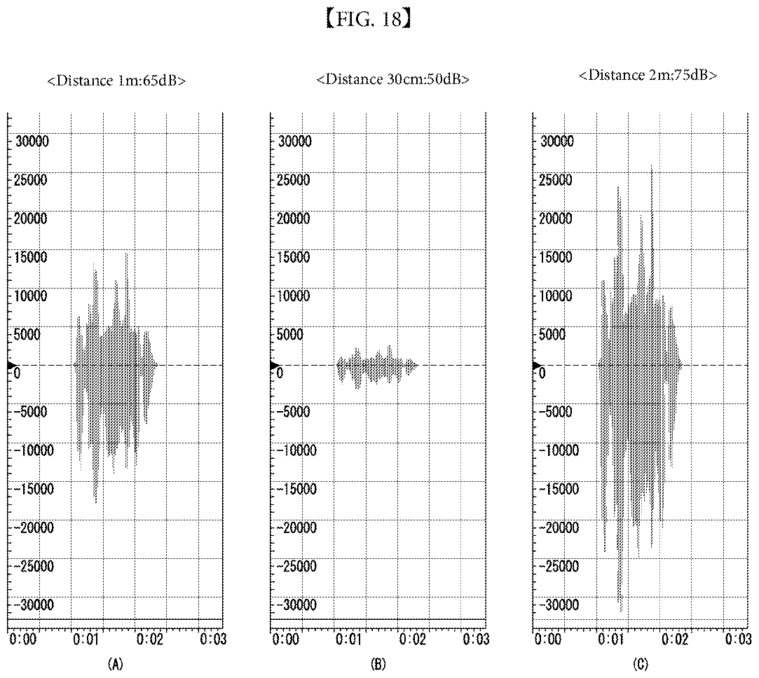

FIG. 17 is a flowchart illustrating a process of performing a response output step (S170 of FIG. 11) using a 5G network.

First, the voice outputting apparatus 10 or the processor 170 of the voice outputting apparatus may control the communication unit 110 to transmit the feature values extracted from the received distance information to the speaker and noise information to the AI processor included in the 5G network. In addition, the processor 170 may control the communication unit to receive AI-processed information from the AI processor.

The AI processed information may include the optimal TTS volume value.

Meanwhile, the processor 170 may perform an initial access procedure with the 5G network to transmit the distance information to the speaker and noise information to the 5G network. The processor 170 may perform the initial access procedure with the 5G network on the basis of a synchronization signal block (SSB).

In addition, the processor 170 may receive, from the network, downlink control information (DCI) used to schedule transmission of the distance information to the speaker and the noise information through a wireless communication unit.

The processor 170 may transmit the distance information to the speaker and the noise information to the network on the basis of the DCI.

The processor 170 may transmit the distance information to the speaker and noise information to the network through a physical uplink shared channel (PUSCH), and the SSB and a demodulation reference signal (DM-RS) of the PUSCH may be quasi-co-located, QCL, for a QCL type D.

The process (S1700) of outputting the TTS by setting an optimal TTS volume value through a network will be described in detail below.

First, the voice outputting apparatus 10 may transmit the feature values extracted from the distance information to the speaker and the noise information to the 5G network (S1710).

Here, the 5G network may include an AI processor or an AI system.

Next, the AI system of the 5G network may perform AI processing on the basis of the received distance information to the speaker and the noise information (S1720).

Hereinafter, the AI processing step S1720 will be described in detail.

First, the AI system may input the feature values of the distance information to the speaker and the noise information received from the voice outputting apparatus 10 to the ANN or an ANN classifier (S1721).

The AI system may obtain an optimal TTS volume value as an ANN output value (S1722). The 5G network may transmit the optimal TTS volume value determined by the AI system to the voice outputting apparatus 10 through the communication unit (S1731).

Meanwhile, the voice outputting apparatus 10 may transmit only the distance information to the speaker and the noise information to the 5G network, and feature values corresponding to an input to be used as an input of the ANN for determining an optimal TTS volume value may be extracted from the distance information to the speaker and the noise information in the AI system included in the 5G network.

FIG. 18 illustrates another example of outputting responses with different optimal TTS volume values.

As illustrated in FIG. 18A, first, the processor 170 may obtain a first voice from a first microphone detection signal.

Next, the processor 170 may capture a first image of a first direction in which the first microphone detection signal is received.

Thereafter, the processor 170 may obtain a distance to the first speaker of the first voice on the basis of the first microphone detection signal and the first image. Specifically, first, the processor 170 may recognize the entire first image and detect a plurality of first persons among a plurality of first objects in the first image. Subsequently, the processor 170 may recognize a face part of each of the first persons in the first image and analyzes the face part of each of the first persons and the first microphone detection signal to determine a first speaker of the first voice among the plurality of the first persons. Thereafter, the processor 170 may estimate a first distance (1 m) from the first speaker of the first voice on the basis of the first microphone detection signal and the first image in the first direction.

Thereafter, the processor 170 may output a first response regarding the first voice on the basis of the first distance (1 m) to the first speaker. Specifically, first, the processor 170 may extract first noise information, which is information related to first noise around the voice outputting apparatus, from the first microphone detection signal. The processor 170 may extract feature values from the first distance to the first speaker of the first voice and the first noise information extracted from the first microphone detection signal. Subsequently, the processor 170 may input the feature values into the previously trained ANN. Thereafter, the processor 170 may obtain an optimal first TTS volume value (65 dB) as an output value of the ANN. Subsequently, the processor 170 may output a first TTS (first response) on the basis of the optimal TTS volume value (65 dB).

As illustrated in FIG. 18B, first, the processor 170 may first obtain a second voice from a second microphone detection signal.

Next, the processor 170 may capture a second image of a second direction in which the second microphone detection signal is received.

Thereafter, the processor 170 may obtain a distance to the second speaker of the second voice on the basis of the second microphone detection signal and the second image. Specifically, first, the processor 170 may recognize the entire second image and detect a plurality of second persons among a plurality of second objects in the second image. Subsequently, the processor 170 may recognize a face part of each of the second persons in the second image and analyzes the face part of each of the second persons and the second microphone detection signal to determine a second speaker of the second voice among the plurality of the second persons. Thereafter, the processor 170 may estimate a second distance (30 cm) from the second speaker of the second voice on the basis of the second microphone detection signal and the second image in the second direction.

Thereafter, the processor 170 may output a second response regarding the second voice on the basis of the second distance (30 cm) to the second speaker. Specifically, first, the processor 170 may extract second noise information, which is information related to second noise around the voice outputting apparatus, from the second microphone detection signal. The processor 170 may extract feature values from the second distance to the second speaker of the second voice and the second noise information extracted from the second microphone detection signal. Subsequently, the processor 170 may input the feature values into the previously trained ANN. Thereafter, the processor 170 may obtain an optimal second TTS volume value (50 dB) as an output value of the ANN. Subsequently, the processor 170 may output a second TTS (second response) on the basis of the optimal TTS volume value (50 dB).

As illustrated in FIG. 18C, first, the processor 170 may obtain a third voice from a third microphone detection signal.

Next, the processor 170 may capture a third image of a third direction in which the third microphone detection signal is received.

Thereafter, the processor 170 may obtain a distance to the third speaker of the third voice on the basis of the third microphone detection signal and the third image. Specifically, first, the processor 170 may recognize the entire third image and detect a plurality of third persons among a plurality of third objects in the third image. Subsequently, the processor 170 may recognize a face part of each of the third persons in the third image and analyzes the face part of each of the third persons and the third microphone detection signal to determine a third speaker of the third voice among the plurality of the third persons. Thereafter, the processor 170 may estimate a third distance (2 m) from the third speaker of the third voice on the basis of the third microphone detection signal and the third image in the third direction.

Thereafter, the processor 170 may output a third response regarding the third voice on the basis of the third distance (2 m) to the third speaker. Specifically, first, the processor 170 may extract third noise information, which is information related to third noise around the voice outputting apparatus, from the third microphone detection signal. The processor 170 may extract feature values from the third distance to the third speaker of the third voice and the third noise information extracted from the third microphone detection signal. Subsequently, the processor 170 may input the feature values into the previously trained ANN. Thereafter, the processor 170 may obtain an optimal third TTS volume value (75 dB) as an output value of the ANN. Subsequently, the processor 170 may output a third TTS (third response) on the basis of the optimal TTS volume value (75 dB).

J. Summary of Embodiment of the Present Invention

Embodiment 1: an intelligent voice outputting method includes: obtaining a voice from a microphone detection signal; capturing an image in a direction in which the microphone detection signal is received; obtaining a distance to a speaker of the voice on the basis of the microphone detection signal and the image; and outputting a response regarding the voice on the basis of the distance to the speaker.

Embodiment 2: In embodiment 1, the obtaining of the distance includes detecting a plurality of objects from the image; and analyzing the plurality of objects and the microphone detection signal to determine a speaker of the voice among the plurality of objects.

Embodiment 3: In embodiment 2, the determining of the speaker of the voice among the plurality of objects includes detecting the speaker of the voice by applying lip reading processing to the plurality of objects and the microphone detection signal.

Embodiment 4: In embodiment 1, the outputting of the response includes: setting an optimal TTS volume corresponding to the distance to the speaker; and outputting the response with the optimal TTS volume.

Embodiment 5: In embodiment 4, the setting of the optimal TTS volume includes: obtaining noise information around the voice outputting apparatus by analyzing the microphone detection signal; and setting the optimal TTS corresponding to the distance to the speaker and the noise information.

Embodiment 6: In embodiment 5, the setting of the optimal TTS volume includes: inputting the distance to the speaker and the noise information to an artificial neural network (ANN); and obtaining the optimal TTS volume as an output of the ANN.

Embodiment 7: In embodiment 6, the ANN is trained in advance using a training set based on the distance and noise information as input values and a predetermined optimal TTS volume value as an output value.

Embodiment 8: In embodiment 1, the method further includes: receiving, from a network, a downlink control information (DCI) used to schedule transmission of the distance to the speaker and the noise information; and transmitting, to the network, the distance to the speaker and the noise information on the basis of downlink control information (DCI).

Embodiment 9: In embodiment 8, the method further includes: performing an initial access procedure with the network on the basis of a synchronization signal block (SSB); and transmitting, to the network, the distance to the speaker and the noise information via a physical uplink shared channel (PUSCH), wherein the SSB and a demodulation reference signal (DM-RS) of the PUSCH are quasi-co-located, QCL, for a QCL type D.

Embodiment 10: In embodiment 8, the method further includes: controlling a communication unit to transmit the distance to the speaker and the noise information to an artificial intelligence (AI) processor included in the network; and controlling the communication unit to receive AI-processed information from the AI processor, wherein the AI processed information may be an optimal TTS volume determined on the basis of the distance to the speaker and the noise information.

Embodiment 11: An intelligent voice outputting apparatus includes: a speaker; at least one microphone detecting an external signal; a camera capturing an image in a direction in which the microphone detection signal is received; and a processor obtaining a voice from the microphone detection signal, obtaining a distance to a speaker of the voice on the basis of the microphone detection signal and the image, and outputting a response regarding the voice through the speaker on the basis of the distance to the speaker.

Embodiment 12: In embodiment 11, the processor detects the plurality of objects from the image and determines the speaker of the voice among the plurality of objects by analyzing the plurality of objects and the microphone detection signal.

Embodiment 13: In embodiment 12, the processor detects the speaker of the voice by applying lip reading processing to the plurality of objects and the microphone detection signal.

Embodiment 14: In embodiment 11, the processor sets an optimal TTS volume corresponding to the distance to the speaker and outputs the response with the optimal TTS volume.

Embodiment 15: In embodiment 14, the processor obtains noise information around the voice outputting apparatus by analyzing the microphone detection signal and sets an optimal TTS volume corresponding to the distance to the speaker and the noise information.

Embodiment 16: In embodiment 15, the processor inputs the distance to the speaker and the noise information to an artificial neural network (ANN) and obtains the optimal TTS volume as an output of the ANN.

Embodiment 17: In embodiment 16, the ANN is trained in advance using a training set based on the distance and noise information as input values and a predetermined optimal TTS volume value as an output value.

Embodiment 18: In embodiment 11, the apparatus further includes: a communication unit transmitting and receiving data to and from the outside, wherein the processor receives, from a network, downlink control information (DCI) used to schedule transmission of the distance to the speaker and the noise information through the communication unit and transmits, to the network, the distance to the speaker and the noise information on the basis of the DCI through the communication unit.

Embodiment 19: In embodiment 18, the processor performs an initial access procedure with the network on the basis of a synchronization signal block (SSB) through the communication unit, and transmits, to the network, the distance to the speaker and the noise information via a physical uplink shared channel (PUSCH), wherein the SSB and a demodulation reference signal (DM-RS) of the PUSCH are quasi-co-located, QCL, for a QCL type D.

Embodiment 20: In embodiment 18, the processor controls the communication unit to transmit the distance to the speaker and the noise information to an artificial intelligence (AI) processor included in the network and controls the communication unit to receive AI-processed information from the AI processor, wherein the AI-processed information is an optimal TTS volume determined on the basis of the distance to the speaker and the noise information.

Embodiment 21: A non-transitory computer-readable recording medium, as a non-transitory computer-readable component storing a computer-executable component configured to be executed in one or more processors of a computing device, obtains a voice from a microphone detection signal, captures an image in a direction in which the microphone detection signal is received, obtains a distance to a speaker of the voice on the basis of the microphone detection signal and the image, and outputs a response regarding the voice on the basis of the distance to the speaker.

The above-described invention may be implemented in computer-readable code in program-recorded media. The computer-readable media include all types of recording devices storing data readable by a computer system. Example computer-readable media may include hard disk drives (HDDs), solid state disks (SSDs), silicon disk drives (SDDs), ROMs, RAMs, CD-ROMs, magnetic tapes, floppy disks, and/or optical data storage, and may be implemented in carrier waveforms (e.g., transmissions over the Internet). The foregoing detailed description should not be interpreted not as limiting but as exemplary in all aspects. The scope of the present invention should be defined by reasonable interpretation of the appended claims and all equivalents and changes thereto should fall within the scope of the invention.

Effects of the intelligent voice outputting method, the voice outputting apparatus, and the intelligent computing device according to an embodiment of the present invention will be described below.

According to the present invention, a response regarding a voice may be effectively transferred to a voice speaker only by the voice outputting apparatus, without the help of an external device.

Further, according to the present invention, by detecting a person on the basis of an image of a front side of the voice outputting apparatus and detecting a distance to a speaker, a response TTS accurately reflecting the distance to the speaker may be output.

Further, according to the present invention, when the user receives a response to speech recognition attempted by the voice outputting apparatus through a TTS, even a nearby user, as well as a remote user, may receive a TTS set to an optimal volume value.

Further, the present invention provides the voice outputting method that can be applied to all types of IoT devices to which speech recognition and a TTS system, such as smart air-conditioners, smart refrigerators, smart air-purifiers, smart speakers, as well as general home appliances.

Further, according to the present invention, since an absolute distance can be accurately measured using image information on the front of the voice outputting apparatus as compared to an existing absolute distance measuring technology using speaking, a magnitude of a response may be set to an optimal volume value.

Further, according to the present invention, in a situation where a plurality of people who speak a command/non-command are simultaneously speaking in front of the voice outputting apparatus, a speaker who speaks a command to the voice outputting apparatus may be accurately identified using a lip reading technique, whereby a distance between the speaker and the voice outputting apparatus can be accurately measured.

What is claimed is:

1. A method for intelligently outputting a voice by a voice outputting apparatus, the method comprising:
obtaining a voice from a microphone detection signal;
capturing an image in a direction in which the microphone detection signal is received;
obtaining a distance to a speaker of the voice on the basis of the microphone detection signal and the image; and
outputting a response regarding the voice on the basis of the distance to the speaker.

2. The method of claim 1, wherein
the obtaining of the distance comprises:
detecting a plurality of objects from the image; and
analyzing the plurality of objects and the microphone detection signal to determine a speaker of the voice among the plurality of objects.

3. The method of claim 2, wherein
the determining of the speaker of the voice among the plurality of objects comprises detecting the speaker of the voice by applying lip reading processing to the plurality of objects and the microphone detection signal.

4. The method of claim 1, wherein
the outputting of the response comprises:
setting an optimal TTS volume corresponding to the distance to the speaker; and
outputting the response with the optimal TTS volume.

5. The method of claim 4, wherein
the setting of the optimal TTS volume comprises:
obtaining noise information around the voice outputting apparatus by analyzing the microphone detection signal; and
setting the optimal TTS corresponding to the distance to the speaker and the noise information.

6. The method of claim 5, wherein
the setting of the optimal TTS volume comprises:
inputting the distance to the speaker and the noise information to an artificial neural network (ANN); and
obtaining the optimal TTS volume as an output of the ANN.

7. The method of claim 6, wherein
the ANN is trained in advance using a training set based on the distance and noise information as input values and a predetermined optimal TTS volume value as an output value.

8. The method of claim 1, further comprising:
receiving, from a network, a downlink control information (DCI) used to schedule transmission of the distance to the speaker and the noise information; and
transmitting, to the network, the distance to the speaker and the noise information on the basis of downlink control information (DCI).

9. The method of claim 8, further comprising:
performing an initial access procedure with the network on the basis of a synchronization signal block (SSB); and
transmitting, to the network, the distance to the speaker and the noise information via a physical uplink shared channel (PUSCH),
wherein the SSB and a demodulation reference signal (DM-RS) of the PUSCH are quasi-co-located, QCL, for a QCL type D.

10. The method of claim 8, further comprising:
controlling a communication module to transmit the distance to the speaker and the noise information to an artificial intelligence (AI) processor included in the network; and
controlling the communication module to receive AI-processed information from the AI processor,
wherein the AI processed information is an optimal TTS volume determined on the basis of the distance to the speaker and the noise information.

11. A voice outputting apparatus comprising:
a speaker;
at least one microphone detecting an external signal;
a camera capturing an image in a direction in which the microphone detection signal is received; and
a processor obtaining a voice from the microphone detection signal, obtaining a distance to a speaker of the voice on the basis of the microphone detection signal and the image, and outputting a response regarding the voice through the speaker on the basis of the distance to the speaker.

12. The voice outputting apparatus of claim 11, wherein
the processor detects the plurality of objects from the image and determines the speaker of the voice among the plurality of objects by analyzing the plurality of objects and the microphone detection signal.

13. The voice outputting apparatus of claim 12, wherein
the processor detects the speaker of the voice by applying lip reading processing to the plurality of objects and the microphone detection signal.

14. The voice outputting apparatus of claim 11, wherein
the processor sets an optimal TTS volume corresponding to the distance to the speaker and outputs the response with the optimal TTS volume.

15. The voice outputting apparatus of claim 14, wherein
the processor obtains noise information around the voice outputting apparatus by analyzing the microphone detection signal and sets an optimal TTS volume corresponding to the distance to the speaker and the noise information.

16. The voice outputting apparatus of claim 15, wherein
the processor inputs the distance to the speaker and the noise information to an artificial neural network (ANN) and obtains the optimal TTS volume as an output of the ANN.

17. The voice outputting apparatus of claim 16, wherein
the ANN is trained in advance using a training set based on the distance and noise information as input values and a predetermined optimal TTS volume value as an output value.

18. The voice outputting apparatus of claim 11, further comprising:
a communication module transmitting and receiving data to and from the outside,
wherein the processor receives, from a network, downlink control information (DCI) used to schedule transmission of the distance to the speaker and the noise information through the communication module and transmits, to the network, the distance to the speaker and the noise information on the basis of the DCI through the communication module.

19. The voice outputting apparatus of claim 18, wherein
the processor performs an initial access procedure with the network on the basis of a synchronization signal block (SSB) through the communication module, and transmits, to the network, the distance to the speaker and the noise information via a physical uplink shared channel (PUSCH),
wherein the SSB and a demodulation reference signal (DM-RS) of the PUSCH are quasi-co-located, QCL, for a QCL type D.

20. The voice outputting apparatus of claim 18, wherein
the processor controls the communication module to transmit the distance to the speaker and the noise information to an artificial intelligence (AI) processor included in the network and controls the communication module to receive AI-processed information from the AI processor,
wherein the AI-processed information is an optimal TTS volume determined on the basis of the distance to the speaker and the noise information.
